(19) United States
(12) Patent Application Publication
(10) Pub. No.: US 2026/0329269 A1
(43) Pub. Date: Oct. 22, 2026

(54) CONVOLUTION-BASED DUAL-INPUT FUZZY SYSTEM AND METHOD FOR DIAGNOSING A MOTOR BEARING FAULT

(71) Applicants: Samar M. Alqhtani, Najran (SA); Muhammad Irfan, Najran (SA); Asadullah Shaikh, Najran (SA); Nabeel A. Khan, Mianwali (PK); Mana Saleh Al Reshan, Najran (SA); Zohaib Mushtaq, Sargodha (PK); Mousa Alalhareth, Najran (SA); Tareq Kareri, Najran (SA); Hamad Almansour, Najran (SA)

(72) Inventors: Samar M. Alqhtani, Najran (SA); Muhammad Irfan, Najran (SA); Asadullah Shaikh, Najran (SA); Nabeel A. Khan, Mianwali (PK); Mana Saleh Al Reshan, Najran (SA); Zohaib Mushtaq, Sargodha (PK); Mousa Alalhareth, Najran (SA); Tareq Kareri, Najran (SA); Hamad Almansour, Najran (SA)

(21) Appl. No.: 19/354,474

(22) Filed: Oct. 9, 2025

(51) Int. Cl. G05B 23/02

(52) U.S. Cl. CPC G05B 23/0278; G05B 23/0221

(57) ABSTRACT

The present disclosure discloses a convolution-based dual-input fuzzy system and method for diagnosing a motor bearing fault. The system includes a signal collecting unit to collect a plurality of input signals from at least one bearing; a data segmenting unit to convert plurality of input signals into a plurality of segments; a feature extracting unit to process the input signals and extract spatial and temporal features for analyzing time-varying speed signals; a fuzzy-based classification unit to calculate fuzzy scores with fuzzy rule weights; a data aggregating unit to aggregate the fuzzy scores and provide a crisp feature output; a processing unit to receive the crisp feature output and process the crisp feature output for final classification of the motor bearing fault; and a classifying unit to classify the motor bearing fault as a healthy motor bearing or a faulty motor bearing.

### TECHNICAL FIELD

The present disclosure relates to the field of fault diagnosing of a motor bearing. More particularly, the present disclosure relates to a convolution-based dual-input fuzzy system and method for diagnosing a motor bearing fault.

### BACKGROUND

To maintain the reliability of motor fault-tolerant control systems, effective bearing fault diagnosis is essential. Bearings are the cornerstone of almost every rotating machine and serve as critical components, their failure can result in prolonged downtime and costly repairs. Fault diagnosis, therefore, plays a crucial role in fault-tolerant control systems. The most common types of bearing defects include inner race, outer race, rolling element, and cage defects.

Traditional methods for diagnosing these defects include vibration analysis, acoustic emission analysis, and thermal imaging. These methods typically employ signal processing techniques such as Fourier Transform (FT), Wavelet Transform (WT), and envelope analysis to detect fault signatures. Although powerful, these approaches often require significant expertise and involve extensive manual data analysis to accurately interpret the information.

Deep learning has emerged as a powerful data-driven approach for bearing fault diagnosis. Convolutional Neural Networks (CNNs), in particular, have shown exceptional performance across various domains due to their ability to automatically extract complex features from raw sensor data without manual intervention. These characteristics make CNNs especially useful for predictive maintenance, helping to prevent secondary damage caused by undiagnosed faults. Recent developments in the fault diagnosis field have focused on incorporating physical prior knowledge into CNN-based fault diagnosis systems to enhance interpretability and prediction accuracy. In addition, ensemble learning techniques have been employed to improve classification precision, including models that automatically extract features using deep CNNs while enriching classifiers such as Random Forest for superior performance. Other approaches have also utilized weighted voting ensembles of lightweight CNNs to achieve improved fault characterization. Such advances highlight the potential of deep learning for highly effective bearing fault diagnosis.

However, despite the impressive approach of deep learning models, including those based on dense layers, several challenges remain. Dense layers often demand significant computational resources and can lead to overfitting when the available data are insufficient. Furthermore, these models are not suited to handle the uncertainties present in real-world industrial environments, where sensor data are often noisy and dynamic. To address these limitations, researchers have integrated fuzzy logic into deep learning frameworks to improve robustness and interpretability. For example, hybrid models have combined CNNs with hierarchical fuzzy entropy technique to enhance simplicity and diagnostic accuracy. Other studies have introduced convolutional fuzzy neural networks designed to classify bearing fault types from vibration sensor data, which improves the handling of uncertainties and enhances fault classification accuracy compared to traditional CNN architectures. Nevertheless, reliance on high-quality vibration data may limit performance in noisy environments, underscoring the need for robust noise-handling mechanisms to maintain consistent accuracy under variable conditions.

In addition, approaches integrating fuzzy-based CNNs with Internet of Things (IoT) frameworks have also been developed to fuse heterogeneous sensing data, thereby improving the robustness and accuracy of fault predictions. Such methods are particularly valuable in IoT contexts, where data originate from diverse sources. However, as the volume of data increases, scalability issues may arise, necessitating the development of more efficient architectures.

Furthermore, most deep learning-based studies rely primarily on vibration data in their training pipelines to diagnose fault types, with only a few incorporating multi-sensor data. Relying solely on one type of input limits the model's ability to learn a diverse set of features and to develop a nuanced understanding of multiple contributing factors that can aid adaptation to unforeseen circumstances. Although autonomous feature extraction—an inherent trait of deep learning modules including CNNs—is a major advantage, the requirement for powerful hardware often hinders applicability due to the high parametric cost. However, a higher parameter count does not always guarantee optimal performance, as it can increase the risk of overfitting. To address slow inference and deploy ability challenges, lightweight networks have been developed, but these often entail performance trade-offs due to inherent model limitations or suboptimal parameter configurations.

Therefore, to overcome the limitations of existing systems, there is a need to develop convolution-based dual-input fuzzy system and method for diagnosing a motor bearing fault. The system integrates both vibrational and rotational speed information for effective fault diagnosis under non-stationary conditions.

### BRIEF SUMMARY

The present disclosure provides a motor bearing fault diagnosis system and method that combines the vibration information with time-varying rotational speed for effective fault diagnosis under non-stationary conditions.

In an embodiment, a convolution-based dual-input fuzzy system for diagnosing a motor bearing fault is disclosed. The system includes a signal collecting unit configured to collect a plurality of input signals from at least one bearing, wherein the plurality of input signals are vibration data and rotational speed data of the at least one bearing; a data segmenting unit configured to convert the plurality of input signals into a plurality of segments and provide a two-dimensional time frequency representation using a Complex Wavelet Transform (CWT) technique to analyse and visualize multi-resolution properties of the input signals; a feature extracting unit configured to process the input vibrational and rotational speed signals and extract spatial and temporal features for analyzing time-varying speed signals by using Split-Operation Fuzzy CNN (SOF-CNN) technique, wherein the feature extracting unit is further configured to provide a first feature map extracted from the rotational speed signals and a second feature map extracted from the vibrational signals through factorized convolution blocks; a fuzzy-based classification unit configured to calculate fuzzy scores with fuzzy rule weights on the first feature map and the second feature map by using an implemented matrix multiplication technique, wherein the fuzzy-based classification unit is further configured to compute the degree to which features belong to each fuzzy rule and capture fuzzy relationships in the signals; a data aggregating unit configured to aggregate the fuzzy scores and provide a crisp feature output by using a de-fuzzy rule layer, wherein the data aggregating unit is further configured to transform the fuzzy scores using the matrix multiplication technique with de-fuzzification weights; a processing unit configured to receive the crisp feature output from the data aggregating unit and process the crisp feature output for final classification of the motor bearing fault; and a classifying unit configured to classify the motor bearing fault as a healthy motor bearing or a faulty motor bearing based on the de-fuzzified outputs.

An objective of the present disclosure is to develop a dual-input fuzzy convolutional neural network system and method that incorporates vibration and time-varying rotational speed data for diagnosing bearing fault. Another objective of the present disclosure is to propose a Least Shannon Entropy Criterion based mother wavelet selection technique for optimal extraction of relevant features from vibrational and rotational speed signals.

Yet, another objective of the present disclosure is to design a lightweight Split-Operation Fuzzy Convolutional Neural Network system using factorized and point wise convolutions. Yet, another objective of the present disclosure is to fuse significant features from vibrational and rotational inputs through an integrated feature fusion pathway for enhanced detection of fault,

Yet, another objective of the present disclosure is to introduce fuzzy rule-based classification layers within the CNN system to enhance interpretability, robustness, and generalization under noisy environments. Yet, another objective of the present disclosure is to evaluate and validate the proposed system across multiple time-varying speed conditions and cross-condition scenarios.

To further clarify advantages and features of the present disclosure, a more particular description of the disclosure will be rendered by reference to specific embodiments thereof, which is illustrated in the appended drawings. It is appreciated that these drawings depict only typical embodiments of the disclosure and are therefore not to be considered limiting of its scope. The disclosure will be described and explained with additional specificity and detail with the accompanying drawings.

### BRIEF DESCRIPTION OF FIGURES

These and other features, aspects, and advantages of the present disclosure will become better understood when the following detailed description is read with reference to the accompanying drawings in which like characters represent like parts throughout the drawings, wherein:

FIG. 1 illustrates a block diagram of a convolution-based dual-input fuzzy system for diagnosing a motor bearing fault in accordance with an embodiment of the present disclosure;

FIG. 2 illustrates a flow diagram of a convolution-based dual-input fuzzy method for diagnosing a motor bearing fault in accordance with an embodiment of the present disclosure;

FIG. 3A illustrates Inner Fault of the Shannon Entropy calculation of vibrational and rotational speed signals subsets for multiple candidate Complex Wavelets at multi-resolution;

FIG. 3B illustrates Outer Fault of the Shannon Entropy calculation of vibrational and rotational speed signals subsets for multiple candidate Complex Wavelets at multi-resolution;

FIG. 3C illustrates Ball Fault of the Shannon Entropy calculation of vibrational and rotational speed signals subsets for multiple candidate Complex Wavelets at multi-resolution;

FIG. 3D illustrates Healthy condition of the Shannon Entropy calculation of vibrational and rotational speed signals subsets for multiple candidate Complex Wavelets at multi-resolution;

FIG. 4 illustrates flow diagram of least Shannon entropy criterion mother wavelet selection technique in accordance with an embodiment of the present disclosure;

FIG. 5 illustrates average Shannon Entropy results for vibration and rotational data in accordance with an embodiment of the present disclosure;

FIG. 6A illustrates results of selected mother wavelet transform (gaus1) for inner race vibrational and inner race rotational data at Increasing Speed Condition in accordance with an embodiment of the present disclosure;

FIG. 6B illustrates results of selected mother wavelet transform (gaus1) for healthy vibrational and healthy rotational data at Increasing Speed Condition in accordance with an embodiment of the present disclosure;

FIG. 6C illustrates results of selected mother wavelet transform (gaus1) for outer race vibrational and outer race rotational data at Increasing Speed Condition in accordance with an embodiment of the present disclosure;

FIG. 6D illustrates results of selected mother wavelet transform (gaus1) for ball vibrational and ball rotational data at Increasing Speed Condition in accordance with an embodiment of the present disclosure;

FIG. 7 depicts a table illustrating Mother Wavelet Selection Techniques with the proposed mother wavelets in accordance with an embodiment of the present disclosure;

FIG. 8 illustrates block diagram of the dual-input split-operation fuzzy CNN system in accordance with an embodiment of the present disclosure;

FIG. 9 illustrates Fuzzy Rule Based CNN Classification Pipeline in accordance with an embodiment of the present disclosure;

FIG. 10A illustrates Inner race Vibrational and inner race Rotational Signal for healthy and faulty states at Increasing Speed Condition (Trail 1) in accordance with an embodiment of the present disclosure;

FIG. 10B illustrates outer race Vibrational and outer race Rotational Signal for healthy and faulty states at Increasing Speed Condition (Trail 1) in accordance with an embodiment of the present disclosure;

FIG. 10C illustrates ball fault Vibrational and ball fault Rotational Signal for healthy and faulty states at Increasing Speed Condition (Trail 1) in accordance with an embodiment of the present disclosure;

FIG. 10D illustrates healthy Vibrational and healthy Rotational Signal for healthy and faulty states at Increasing Speed Condition (Trail 1) in accordance with an embodiment of the present disclosure;

FIG. 11A illustrates Fourier power spectrum for inner race vibrational and inner race rotational signal at increasing speed condition (trail-1) in accordance with an embodiment of the present disclosure;

FIG. 11B illustrates Fourier power spectrum for outer race vibrational and outer race rotational signal at increasing speed condition (trail-1) in accordance with an embodiment of the present disclosure;

FIG. 11C illustrates Fourier power spectrum for ball fault vibrational and ball fault rotational signal at increasing speed condition (trail-1) in accordance with an embodiment of the present disclosure;

FIG. 11D illustrates Fourier power spectrum for healthy vibrational and healthy rotational signal at increasing speed condition (trail-1) in accordance with an embodiment of the present disclosure;

FIG. 12 depicts a table illustrating parametric configuration for proposed SOF-CNN architecture in accordance with an embodiment of the present disclosure;

FIG. 13 depicts table 3 illustrates selected operating conditions for dataset in accordance with an embodiment of the present disclosure;

FIG. 14 depicts table 4 illustrates frequency range of dataset for all four time-varying rotational speed conditions in accordance with an embodiment of the present disclosure;

FIG. 15A illustrates 10-folds cross validation results for increasing speed operating conditions with 3 trails in accordance with an embodiment of the present disclosure;

FIG. 15B illustrates 10-folds cross validation results for decreasing speed operating conditions with 3 trails in accordance with an embodiment of the present disclosure;

FIG. 15C illustrates 10-folds cross validation results for increase then decrease operating conditions with 3 trails in accordance with an embodiment of the present disclosure;

FIG. 15D illustrates 10-folds cross validation results for decrease then increase operating conditions with 3 trails in accordance with an embodiment of the present disclosure;

FIG. 16 depicts Table 5 illustrates dataset features and sample distribution in accordance with an embodiment of the present disclosure;

FIG. 17 illustrates Hyper-parameter selection heat-map for the proposed model depicting the validation performance for different combinations of rules and learning rates in accordance with an embodiment of the present disclosure;

FIG. 18 illustrates summed absolute fuzzy rules weight distribution for different input features in accordance with an embodiment of the present disclosure;

FIG. 19 illustrates fuzzy membership weights for different classes in accordance with an embodiment of the present disclosure; and

FIG. 20 illustrates depiction of proposed SOF-CNN system's inference and class allocation process on vibrational and rotational inputs in accordance with an embodiment of the present disclosure.

Further, skilled artisans will appreciate that elements in the drawings are illustrated for simplicity and may not have been necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having benefit of the description herein.

### DETAILED DESCRIPTION:

For the purpose of promoting an understanding of the principles of the disclosure, reference will now be made to the embodiment illustrated in the drawings and specific language will be used to describe the same. It will nevertheless be understood that no limitation of the scope of the disclosure is thereby intended, such alterations and further modifications in the illustrated system, and such further applications of the principles of the disclosure as illustrated therein being contemplated as would normally occur to one skilled in the art to which the disclosure relates. It will be understood by those skilled in the art that the foregoing general description and the following detailed description are exemplary and explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment. The terms “comprises”, “comprising”, or any other variations thereof, are intended to cover a non-exclusive inclusion, such that a process or method that comprises a list of steps does not include only those steps but may include other steps not expressly listed or inherent to such process or method. Similarly, one or more devices or sub-systems or elements or structures or components proceeded by “comprises . . . ” does not, without more constraints, preclude the existence of other devices or other sub-systems or other elements or other structures or other components or additional devices or additional sub-systems or additional elements or additional structures or additional components.

Unless otherwise defined, all technical and scientific terms used herein have the same meaning as commonly understood by one of ordinary skill in the art to which this disclosure belongs. The system, methods, and examples provided herein are illustrative only and not intended to be limiting. Embodiments of the present disclosure will be described below in detail with reference to the accompanying drawings.

The functional units described in this specification have been labeled as devices. A device may be implemented in programmable hardware devices such as processors, digital signal processors, central processing units, field programmable gate arrays, programmable array logic, programmable logic devices, cloud processing systems, or the like. The devices may also be implemented in software for execution by various types of processors. An identified device may include executable code and may, for instance, comprise one or more physical or logical blocks of computer instructions, which may, for instance, be organized as an object, procedure, function, or other construct. Nevertheless, the executable of an identified device need not be physically located together, but may comprise disparate instructions stored in different locations which, when joined logically together, comprise the device and achieve the stated purpose of the device.

Indeed, an executable code of a device or module could be a single instruction, or many instructions, and may even be distributed over several different code segments, among different applications, and across several memory devices. Similarly, operational data may be identified and illustrated herein within the device, and may be embodied in any suitable form and organized within any suitable type of data structure. The operational data may be collected as a single data set, or may be distributed over different locations including over different storage devices, and may exist, at least partially, as electronic signals on a system or network.

In accordance with the exemplary embodiments, the disclosed computer programs or modules can be executed in many exemplary ways, such as an application that is resident in the memory of a device or as a hosted application that is being executed on a server and communicating with the device application or browser via a number of standard protocols, such as TCP/IP, HTTP, XML, SOAP, REST, JSON and other sufficient protocols. The disclosed computer programs can be written in exemplary programming languages that execute from memory on the device or from a hosted server, such as BASIC, COBOL, C, C++, Java, Pascal, or scripting languages such as JavaScript, Python, Ruby, PHP, Perl or other sufficient programming languages.

Some of the disclosed embodiments include or otherwise involve data transfer over a network, such as communicating various inputs or files over the network. The network may include, for example, one or more of the Internet, Wide Area Networks (WANs), Local Area Networks (LANs), analog or digital wired and wireless telephone networks (e.g., a PSTN, Integrated Services Digital Network (ISDN), a cellular network, and Digital Subscriber Line (xDSL)), radio, television, cable, satellite, and/or any other delivery or tunneling mechanism for carrying data. The network may include multiple networks or sub networks, each of which may include, for example, a wired or wireless data pathway. The network may include a circuit-switched voice network, a packet-switched data network, or any other network able to carry electronic communications. For example, the network may include networks based on the Internet protocol (IP) or asynchronous transfer mode (ATM), and may support voice using, for example, VoIP, Voice-over-ATM, or other comparable protocols used for voice data communications. In one implementation, the network includes a cellular telephone network configured to enable exchange of text or SMS messages.

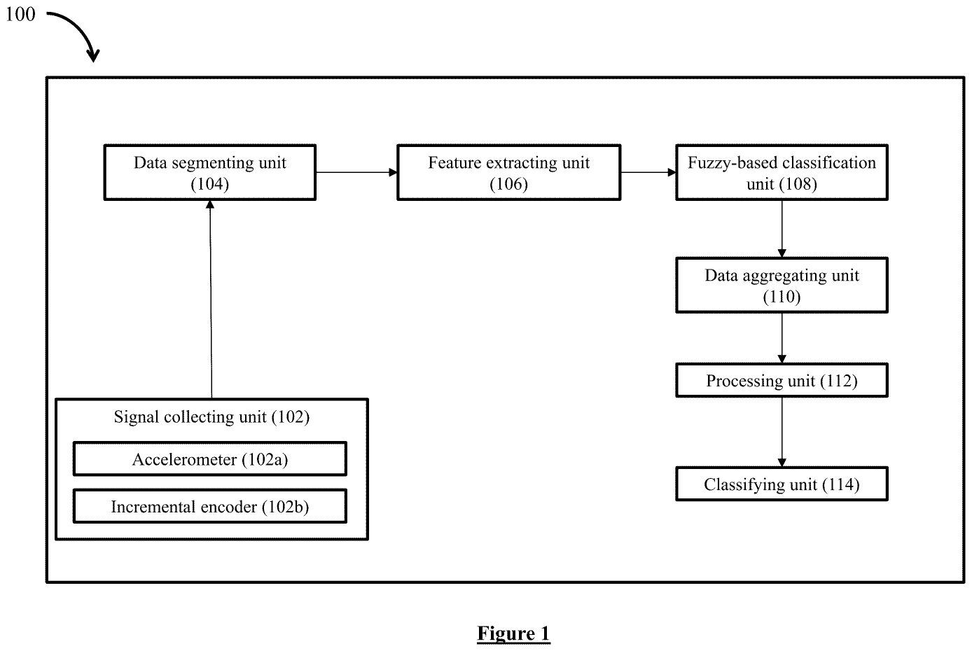

Referring to FIG. 1, a block diagram of a convolution-based dual-input fuzzy system (100) for diagnosing a motor bearing fault is illustrated. The system (100) comprising a signal collecting unit (102) configured to collect a plurality of input signals from at least one bearing, wherein the plurality of input signals are vibration data and rotational speed data of the at least one bearing.

In an embodiment, a data segmenting unit (104) configured to convert the plurality of input signals into a plurality of segments and provide a two-dimensional time frequency representation using a Complex Wavelet Transform (CWT) technique to analyse and visualize multi-resolution properties of the input signals. In another embodiment, a feature extracting unit (106) configured to process the input vibrational and rotational speed signals and extract spatial and temporal features for analyzing time-varying speed signals by using Split-Operation Fuzzy CNN (SOF-CNN) technique, wherein the feature extracting unit (106) is further configured to provide a first feature map extracted from the rotational speed signals and a second feature map extracted from the vibrational signals through factorized convolution blocks.

In another embodiment, a fuzzy-based classification unit (108) configured to calculate fuzzy scores with fuzzy rule weights on the first feature map and the second feature map by using an implemented matrix multiplication technique, wherein the fuzzy-based classification unit (108) is further configured to compute the degree to which features belong to each fuzzy rule and capture fuzzy relationships in the signals. In another embodiment, a data aggregating unit (110) configured to aggregate the fuzzy scores and provide a crisp feature output by using a de-fuzzy rule layer, wherein the data aggregating unit (110) is further configured to transform the fuzzy scores using the matrix multiplication technique with de-fuzzification weights. In another embodiment, a processing unit (112) configured to receive the crisp feature output from the data aggregating unit and process the crisp feature output for final classification of the motor bearing fault.

In another embodiment, a classifying unit (114) configured to classify the motor bearing fault as a healthy motor bearing or a faulty motor bearing based on the de-fuzzified outputs. In another embodiment, the signal collecting unit (102) comprising an accelerometer (102a) fixed to housing of the bearing configured to capture vibrations of the bearing and an incremental encoder (102b) configured to record rotational speed of a shaft coupled with the bearing, wherein the incremental encoder (102b) is further configured to record incremental speed, decremental speed, incremental and subsequent decremental speed and a series of decremental and incremental speed.

In another embodiment, a signal processing unit (116) configured to process the signals to minimize edge effects in every segment and reduce discontinuities at boundaries of the signals by using a Hanning window technique, wherein the signal processing unit (116) is further configured to minimize distortions caused by boundary effects. In some embodiment, the processing unit (112) is configured to identify uncertainty of the signals by using the least Shannon entropy criterion technique, wherein the processing unit (112) indicates a lower value, which suggests highly relevant content and lower noise content. In one embodiment, the processing unit (112) is configured to apply Least Shannon Criterion Complex Wavelet Selection technique to effectively identify an optimal complex wavelet type for analyzing vibrational and rotational speed signals.

In an embodiment, the feature extracting unit (106) is configured to preprocess the vibration and rotational speed signals by dividing the continuous input streams into a plurality of overlapping frames, each frame being generated through a frame construction technique that continuously evaluates the local variance and frequency distribution of the incoming signals, computes an adaptive frame length proportional to said variance, and assigns an overlap ratio based on the instantaneous rate of change of frequency content, and wherein each constructed frame is normalized by amplitude scaling and baseline shifting before being input to the factorized convolution blocks, and wherein the factorized convolution blocks are further configured to apply a kernel bank of variable dilation rates across the overlapping frames so that both short-lived transient impulses and long-duration oscillatory cycles are structurally encoded in the generated first feature map and second feature map.

In this embodiment, the feature extracting unit (106) operates as the primary stage of signal transformation where raw vibration and rotational speed data streams are converted into structured feature maps suitable for advanced analysis. The process begins with continuous acquisition of signals from the accelerometer and encoder. Instead of segmenting these signals into fixed-length frames, which may overlook critical variations, the system employs a dynamic frame construction technique. This technique evaluates the local variance and frequency distribution of the incoming data in real time. For instance, if the vibration signal exhibits sudden high-frequency bursts associated with an incipient crack in the bearing surface, the technique shortens the frame length so that the spike is captured with high fidelity. Conversely, during steady-state operation where the variance is low, the frame length is increased to avoid redundant segmentation and computational inefficiency.

Each constructed frame is overlapped with the preceding and succeeding frames to ensure continuity of information across boundaries. The overlap ratio itself is adaptive, determined by monitoring the instantaneous rate of change in the frequency content. For example, during rapid acceleration or deceleration events, the overlap ratio is increased so that transitional details are preserved, whereas in more stable operating regions, the overlap ratio is reduced to minimize unnecessary duplication. Before being forwarded, each frame undergoes amplitude scaling to normalize signal magnitudes and baseline shifting to eliminate DC offsets that might bias convolutional processing. This normalization ensures that the subsequent feature extraction is invariant to amplitude differences caused by external factors such as load variations or sensor gain mismatches. Once normalized, the frames are processed through a set of factorized convolution blocks. These blocks deploy a kernel bank with variable dilation rates applied across the overlapping frames. Smaller dilation rates act as fine-resolution filters that capture short-lived transients such as impact impulses or localized surface roughness, which are often early indicators of mechanical degradation. Larger dilation rates, on the other hand, capture extended oscillatory cycles that correspond to repetitive mechanical imbalances or misalignment conditions. By encoding both types of signal behaviors simultaneously into the first and second feature maps, the system generates a multi-scale representation of the signal dynamics.

To illustrate, consider a rotating machine that begins to develop an inner race defect. In the early stage, the accelerometer records sharp transient impulses at irregular intervals. These are captured by the fine dilation kernels in the factorized convolution blocks. As the defect progresses, these impulses start repeating in synchrony with the rotational cycle, introducing a longer-term oscillatory signature. The larger dilation kernels capture this periodicity, ensuring that the model encodes both the transient initiation and the sustained fault behavior. In this way, the preprocessing and convolution stages collectively enable the system to not only detect anomalies earlier but also characterize their evolution over time, advancing diagnostic capability beyond conventional fixed-frame, single-scale feature extraction approaches.

In an embodiment, the feature extracting unit (106) is further configured to apply parallelized convolution operations across segmented inputs by distributing multiple segments simultaneously to independent convolutional cores, each core being assigned a subset of kernels with fixed dilation and stride values, and wherein outputs from the parallel cores are concatenated along a feature dimension, reordered by temporal indices, and recombined into the rotational and vibrational feature maps without altering temporal alignment across segments. The parallel convolution operations enable the system to exploit concurrency at the hardware or GPU level, significantly reducing the latency of processing large-scale vibration datasets. Once convolutional outputs are generated by the independent cores, they are concatenated along a designated feature dimension. At this stage, the raw order of concatenation does not necessarily reflect the original signal chronology, so the system implements a temporal reordering step. This step maps the output features back to their original segment timestamps, ensuring that every extracted feature vector remains aligned with the actual progression of the vibration or rotational signal. For instance, if three segments were distributed to three cores, the concatenated feature maps are reordered so that segment one's output is aligned before segment two and segment three, regardless of which core processed it faster.

After temporal realignment, the recombined outputs are structured into two distinct yet synchronized feature maps: one for vibration data and one for rotational data. This recombination preserves the intrinsic temporal order of the machinery's behavior, which is crucial when diagnosing conditions such as bearing defects that manifest as a sequence of harmonically related events. To illustrate, if the machine is operating under a fluctuating load condition, the vibration features processed by one core might capture stress-induced bursts while the rotational speed features processed by another core might capture torque ripple patterns. By recombining them in a temporally accurate manner, the system ensures that the eventual diagnostic interpretation recognizes that both phenomena occurred concurrently in the same operational window. This embodiment advances signal analysis beyond sequential convolution pipelines by exploiting parallelization without sacrificing temporal integrity. Conventional models often either lose ordering information during parallel execution or restrict themselves to serial convolution, which increases computational overhead. By contrast, this architecture both accelerates throughput and maintains accurate temporal correspondence between vibration and rotational domains, enabling faster and more precise fault detection.

In an embodiment, the factorized convolution blocks of the feature extracting unit (106) are configured to execute a kernel reassignment routine across the rotational signal feature extraction path and the vibrational signal feature extraction path, the kernel reassignment routine comprising computing a correlation matrix between localized subsections of the rotational signal and corresponding subsections of the vibrational signal, updating a similarity threshold dynamically in each processing cycle as a function of the average correlation of previously processed subsections, and transferring active convolution kernels between the two paths when correlation values exceed the similarity threshold, while independently reinitializing kernels when correlation values fall below the threshold, and wherein the reassigned kernels are retrained using gradient update rules applied simultaneously across both paths to maintain synchronized structural encoding of correlated subsections.

The similarity threshold, used to determine whether kernels should be reassigned, is not static but dynamically updated in each processing cycle. The update mechanism uses the average correlation of subsections from previously processed cycles as a feedback reference. This ensures that the system adapts to evolving fault conditions: during early stages of wear, correlations between vibration impulses and rotational irregularities may be weak, while at advanced stages they become more pronounced. For instance, as a crack propagates in a bearing surface, the coupling between vibration transients and speed irregularities increases, prompting the system to adjust its similarity threshold so that kernels can be more readily exchanged between the two processing paths.

When correlation values between subsections exceed the current similarity threshold, active convolution kernels trained on one signal path are transferred to the other. For example, a kernel specialized in detecting periodic impulses within the vibration domain may be reassigned to the rotational signal path once correlation analysis reveals that similar patterns are emerging in rotational speed. This allows the rotational signal path to immediately benefit from the representational capacity already developed in the vibration path, rather than having to retrain from scratch. Conversely, when correlation values fall below the threshold, suggesting that the relationship between the two signals is weak or noisy, kernels are reinitialized independently on each path. This prevents inappropriate sharing of features that could otherwise confuse the encoding process.

Once reassigned, the kernels are not left static but are retrained through gradient update rules applied simultaneously across both paths. This ensures that the reassigned kernels remain responsive to the evolving dynamics of each signal type while maintaining a synchronized structural encoding. For example, if a reassigned kernel is detecting both vibration impulses and correlated speed dips, gradient updates in both paths reinforce its ability to represent the shared subsections while refining its sensitivity to the unique aspects of each modality. This embodiment enables adaptive cross-learning between vibration and rotational domains, which directly enhances diagnostic sensitivity. Traditional architectures treat vibration and rotation features in isolation, potentially missing the nuanced interplay between the two. By dynamically transferring and retraining kernels based on signal correlation, this system not only accelerates learning but also strengthens the joint representation of fault conditions, resulting in more precise recognition of fault onset and progression across different operating conditions.

In an embodiment, the fuzzy-based classification unit (108) is configured to calculate fuzzy rule weights through a hierarchical fuzzification framework, the framework comprising a first fuzzification stage in which each feature in the first and second feature maps is assigned a preliminary membership degree by evaluating its instantaneous magnitude together with its temporal derivative calculated over a sliding analysis window, a second fuzzification stage in which the preliminary membership degrees are recalibrated by computing inter-feature similarity indices across spatially adjacent feature nodes, adjusting membership values based on the average similarity of each feature to its neighbors, and a tensor construction stage in which the recalibrated membership values are assembled into a multi-dimensional rule activation tensor indexed by feature position and rule identifier, the rule activation tensor being stored in memory prior to application of fuzzy rule weights. In this embodiment, the fuzzy-based classification unit (108) implements a hierarchical fuzzification framework that transforms the extracted feature maps into a structured representation suitable for applying fuzzy logic rules. The process begins with the first fuzzification stage, where each feature derived from the convolutional encoding of vibration and rotational speed signals is examined in terms of both its instantaneous magnitude and its temporal evolution. To capture this evolution, the system calculates the temporal derivative of the feature using a sliding analysis window that shifts continuously along the time axis. For example, if a feature represents a localized vibration impulse, the fuzzification unit not only evaluates its present amplitude but also determines whether its intensity is increasing, decreasing, or stable. This dual consideration allows the membership degree to reflect not just a static state but also a dynamic trend, which is crucial when diagnosing progressive conditions such as bearing wear that evolve over successive cycles.

The second fuzzification stage refines these preliminary membership degrees by embedding contextual information from spatially adjacent feature nodes. Inter-feature similarity indices are computed to determine how closely each feature relates to its neighbors within the feature map. This step acts as a form of contextual calibration: if a given node exhibits weak activation but is surrounded by strongly activated neighbors with similar frequency and temporal properties, its membership value is adjusted upward to better reflect the collective signal pattern. Conversely, isolated activations with little similarity to adjacent nodes are downweighted to prevent spurious noise-driven contributions. For instance, if three consecutive nodes along the vibration map indicate high membership in a rule corresponding to outer race fault signatures, while a fourth node shows only weak membership, the similarity-based recalibration enhances the weak node to preserve continuity of fault representation. This improves the reliability of rule activation by reducing the impact of random outliers or sensor noise.

Following this recalibration, the system executes a tensor construction stage, where the updated membership values are organized into a multi-dimensional rule activation tensor. Each element in this tensor is indexed both by the spatial position of the feature within the map and by the identifier of the fuzzy rule it corresponds to. This tensor serves as a structured repository where all membership values are systematically aligned, ensuring that rule activations can be accessed efficiently during classification. The tensor is stored in memory and acts as an intermediate knowledge base linking the extracted features with their associated fuzzy logic rules.

In an embodiment, the fuzzy-based classification unit (108) further comprises a conflict resolution sub-module configured to operate on the rule activation tensor whenever multiple fuzzy rules achieve overlapping membership degrees for a given feature node, the conflict resolution sub-module being configured to generate a temporal persistence profile for each fuzzy rule by recording activation magnitudes across sequential time windows, calculate persistence coefficients proportional to the cumulative activation strength of each fuzzy rule, rank the fuzzy rules for each feature node according to the persistence coefficients, and update the rule activation tensor by retaining the fuzzy rule with the highest persistence coefficient while suppressing the overlapping rules, such that the updated tensor contains only rule activations that satisfy the persistence criteria across time. The conflict resolution sub-module addresses this by constructing a temporal persistence profile for each fuzzy rule. As the system processes input over sequential time windows, it records the activation magnitudes of each rule for a given feature node. These activations are accumulated to calculate persistence coefficients, which represent the sustained strength of rule activation over time rather than at a single instant. For instance, if a fuzzy rule indicating “cage defect” consistently maintains strong activation across multiple cycles, its persistence coefficient will be higher than another rule that only shows sporadic activation in response to transient noise. Once persistence coefficients are established, the rules are ranked for each feature node according to their cumulative strength. The sub-module then updates the rule activation tensor by retaining only the rule with the highest persistence coefficient, while suppressing others that overlap at that node. This ensures that the final tensor reflects not just immediate activations but the rule that has demonstrated the most reliable and consistent presence over a meaningful time horizon.

Consider a practical example: in a motor bearing undergoing gradual outer race degradation, vibration signals may intermittently trigger rules for both “outer race defect” and “imbalance.” While imbalance rules may fire occasionally due to temporary load changes, the outer race defect rule will persistently activate as the fault progresses. The conflict resolution sub-module calculates higher persistence coefficients for the outer race defect rule and suppresses imbalance activations in the tensor. This refinement ensures that the system converges toward the correct diagnosis over time, even when temporary or misleading activations occur. By incorporating temporal persistence as the basis for resolving rule conflicts, this embodiment enables the classifier to prioritize fault conditions that are consistently supported by signal evidence, while minimizing the influence of transient or noisy overlaps. This structured pruning of the rule activation tensor enhances the decisiveness of the classification process and reduces false positives, advancing the system's reliability in long-term deployment.

In an embodiment, the fuzzy-based classification unit (108) is further configured to incorporate a feedback adaptation mechanism that modifies fuzzy rule weights in response to persistent classification discrepancies, the mechanism comprising detecting repeated conflicts between vibration-derived classifications and rotation-derived classifications, calculating a correction coefficient proportional to the frequency of such conflicts, and applying the correction coefficient to adjust the weighting of conflicting rules in subsequent fuzzification cycles. The mechanism begins by continuously monitoring the outcomes of both the vibration-driven and rotation-driven classification paths. Each time a discrepancy is detected—for example, vibration-based features may suggest an “inner race defect” while rotation-based features classify the same time window as “shaft imbalance” the system records the conflict. When such conflicts repeat across multiple analysis cycles, they are no longer treated as random deviations but as persistent contradictions that require adaptive correction.

To quantify this, the system calculates a correction coefficient that is proportional to the frequency of conflicts observed over a defined monitoring interval. The coefficient represents how strongly a particular pair of rules (one from the vibration domain, one from the rotational domain) is implicated in contradictory outcomes. For instance, if vibration-based rules consistently suggest outer race defects while rotational rules suggest lubrication failure, the correction coefficient linking these two rules increases with each repeated conflict. This coefficient acts as a feedback signal to regulate future weighting. Once calculated, the correction coefficient is applied during subsequent fuzzification cycles to adjust the weighting of the conflicting rules. The adjustment is not absolute but proportional, ensuring that neither signal domain is completely suppressed. Instead, the mechanism reduces the dominance of rules that have been repeatedly contradicted, while relatively amplifying those that align better across both domains. Over successive iterations, this feedback loop allows the fuzzy-based classification unit to converge toward a consistent interpretation that balances the evidence from vibration and rotational speed signals.

For example, consider a motor bearing operating under fluctuating load. In the early stage of fault development, vibration features may highlight transient impacts misinterpreted as imbalance, while rotational speed features suggest irregular torque indicative of misalignment. As the conflict between these rules persists, the adaptation mechanism gradually downweights the imbalance interpretation while reinforcing the misalignment pathway, until both signal domains converge on the more plausible fault condition. It ensures that the diagnostic system does not remain locked in conflicting outputs but evolves to reflect the underlying mechanical reality as more data becomes available, improving long-term accuracy and adaptability in complex operating environments.

In an embodiment, the fuzzy-based classification unit (108) further comprises a temporal smoothing engine configured to monitor membership value fluctuations across successive time windows, compute moving averages of membership activations, and substitute raw membership values with smoothed averages whenever variance exceeds a preset fluctuation threshold, the smoothed membership activations being used for further de-fuzzification. Since vibration and rotational speed signals often contain short-lived spikes caused by electrical interference, sudden load changes, or environmental disturbances, the raw membership values derived directly from features can fluctuate sharply from one analysis window to the next. If left unfiltered, these fluctuations may propagate into the classification stage, leading to inconsistent outputs. To address this, the temporal smoothing engine continuously monitors the evolution of membership activations across successive time windows. For each fuzzy rule applied to a feature, the engine calculates a moving average of its activation strength over a sliding window of time. This running average is updated dynamically as new data points arrive, allowing the system to account for recent history while maintaining computational efficiency. Alongside the moving average, the engine evaluates the variance of the membership activations within the same window. When the variance exceeds a predefined fluctuation threshold, it indicates that the raw membership values are oscillating too strongly to be reliable. In such cases, the raw value for that cycle is substituted with the smoothed average, effectively dampening the erratic changes.

For example, suppose a bearing under normal operation encounters a brief load surge that introduces a transient spike in the vibration data. This spike could momentarily increase the membership value for a “cage defect” rule, even though no actual defect exists. The temporal smoothing engine detects the high variance between this spike and the preceding stable values, replaces the anomalous membership activation with the moving average, and thus prevents the false indication from propagating to the next stage. On the other hand, if a genuine fault begins to develop, the membership values will rise consistently across multiple windows, resulting in lower variance relative to the mean. In this case, the smoothing engine passes the raw membership activations unchanged, preserving the sensitivity of the classifier to real fault conditions. By introducing this adaptive smoothing process, the fuzzy-based classification unit produces membership activations that are both stable and representative of long-term signal behavior. The downstream de-fuzzification module, which relies on the consistency of inputs to generate crisp outputs, can therefore operate with improved reliability. This embodiment reduces false positives due to transient disturbances while ensuring that persistent patterns indicating mechanical degradation are preserved, enhancing the dependability of the classification pipeline in practical industrial environments.

In an embodiment, the data aggregating unit (110) is configured to transform fuzzy membership values into crisp feature outputs through a structured two-pass de-fuzzification operation, the two-pass operation comprising a first pass in which the membership values are arranged into a rule-feature matrix, multiplied with a weight matrix calibrated during system initialization, and aggregated into preliminary crisp values, and a second pass in which the dispersion of membership activations across rules is computed as a dispersion index, the dispersion index being applied to modify the coefficients of the weight matrix, and wherein the modified weight matrix is applied in a repeated matrix multiplication with the membership values to produce final crisp feature outputs, the final crisp outputs being transmitted to the processing unit (112). This dual-layer approach ensures that the crisp values forwarded to the processing unit (112) reflect not only the weighted influence of fuzzy rules but also the distributional characteristics of their activations, which is essential for generating reliable diagnostics.

During the first pass, the membership values obtained from the fuzzy-based classification unit are arranged into a structured rule-feature matrix. Each row of this matrix corresponds to a fuzzy rule, while each column represents a feature node extracted from the vibration or rotational signal maps. A weight matrix, calibrated during system initialization, is applied to this structure. These weights encode the initial importance of each rule relative to diagnostic priorities. For example, rules corresponding to critical fault types, such as “outer race spalling,” may be initialized with higher coefficients than rules corresponding to less critical conditions, such as “temporary load imbalance.” Through matrix multiplication, the system aggregates these weighted memberships into a set of preliminary crisp values. At this stage, the outputs represent the raw translation of fuzzy logic into numerical form, but they may still carry uncertainty if competing rules were strongly activated. The second pass addresses this uncertainty by computing a dispersion index for each feature. The dispersion index quantifies how widely the membership activations are spread across different fuzzy rules. For instance, if a vibration feature activates both “inner race defect” and “lubrication degradation” rules with similar intensity, the dispersion index will be high, signaling ambiguity. Conversely, if one rule dominates, the dispersion index will be low. The calculated dispersion index is then used to modify the coefficients of the weight matrix. Rules that contribute to high dispersion are slightly down weighted, while rules contributing to consistent activation retain or gain influence. This adjustment ensures that ambiguous conditions are represented with moderated crisp values, preventing the system from overcommitting to uncertain classifications.

After updating the weight matrix with dispersion-driven adjustments, the system repeats the matrix multiplication with the same rule-feature membership matrix. This second computation yields the final crisp outputs, which more accurately reflect both the weighted rule activations and the distribution of uncertainty across rules. These final crisp values are then transmitted to the processing unit (112) for higher-level aggregation, verification, and eventual diagnostic labeling.

In an embodiment, the data aggregating unit (110) is configured to execute a weighted normalization procedure on fuzzy scores before applying de-fuzzification, the weighted normalization procedure comprising summing membership activations across all fuzzy rules, computing a normalization constant, dividing each membership activation by the normalization constant, and scaling the normalized activations using rule-specific weight multipliers stored in memory, the scaled activations being arranged into a normalized rule-feature matrix for subsequent crisp value computation. The normalization procedure begins by summing all membership activations across the full set of fuzzy rules for a given feature node. This sum acts as a normalization constant representing the total activation energy for that feature within a given analysis cycle. Each individual membership activation is then divided by this normalization constant, effectively scaling the values so that their combined total equals one. This step removes scale distortions introduced by variations in signal intensity, ensuring that all rules contribute proportionally to the same feature space. For example, if a vibration feature strongly activates three rules but with different magnitudes, dividing by the normalization constant guarantees that the activations are compared fairly within the same normalized range.

Once normalized, the system introduces an additional scaling layer based on stored rule-specific weight multipliers. These multipliers are predetermined during system configuration and reflect the criticality of certain fault modes. For instance, a rule associated with “catastrophic bearing failure” may be assigned a higher weight multiplier than a rule linked to “temporary imbalance,” since the former represents a more severe operational risk. Applying these multipliers ensures that, even after normalization, critical rules retain the ability to exert stronger influence on the downstream crisp value computation. This balance between normalized equality and priority scaling allows the system to remain sensitive to critical faults without being skewed by raw signal magnitude. The scaled values are then arranged into a normalized rule-feature matrix, which serves as the structured input for the subsequent crisp value computation process. This matrix preserves the normalized relationships among rules for each feature while embedding the importance factors necessary for reliable decision-making. For example, if a rotational speed feature activates both “shaft misalignment” and “unbalanced load” rules, normalization ensures both are fairly represented, while weighting multipliers may give preference to “misalignment” if it is defined as more critical.

By executing this weighted normalization procedure, the system achieves two important advancements. First, it prevents numerical bias from raw membership values that may differ solely due to input amplitude variations rather than true diagnostic importance. Second, it encodes domain knowledge about fault criticality into the classification process by applying rule-specific multipliers. This ensures that the crisp outputs generated after de-fuzzification reflect both the proportional balance of activations and the practical priority of fault conditions, producing results that are both technically fair and diagnostically meaningful.

In an embodiment, the processing unit (112) is configured to apply a complex wavelet selection routine by computing least Shannon entropy values for candidate wavelet functions applied to the vibration and rotational speed signals, ranking the candidate wavelets according to entropy values, selecting the wavelet function with the lowest entropy for subsequent time-frequency transformation, and updating the selection dynamically when incoming signals exhibit changes in entropy values that alter the ranking of candidate wavelets. Traditional wavelet-based analysis often relies on a predetermined mother wavelet chosen during system configuration. While effective under certain operating conditions, a fixed choice may not be suitable for signals that change significantly over time, such as those generated by rotating machinery undergoing varying loads, speed transitions, or progressive fault development. To address this limitation, the system dynamically evaluates candidate wavelet functions in real time and selects the most appropriate one based on entropy minimization.

The process begins by applying a set of candidate complex wavelet functions to the incoming vibration and rotational speed data streams. Each candidate produces a time-frequency decomposition of the signals, capturing localized oscillatory patterns at multiple resolution levels. To assess the suitability of each wavelet, the system computes the Shannon entropy of the resulting coefficients. Shannon entropy provides a measure of signal information compactness: a lower entropy value indicates that the decomposition has concentrated the signal's energy into fewer, more significant coefficients, which implies a clearer and more informative representation of the underlying fault characteristics. Once entropy values are calculated for all candidates, the wavelets are ranked according to their entropy results. The wavelet with the lowest entropy value is selected as the optimal choice for that processing cycle. For example, if a machine develops a localized bearing fault that produces sharp transients, a complex Morlet wavelet may yield the most compact coefficient distribution, while under smoother torque ripple conditions, a complex Coiflet may achieve better concentration. By selecting the lowest-entropy wavelet, the system ensures that subsequent time-frequency transformation captures the most diagnostically relevant features with minimal redundancy.

The routine is not static; it updates dynamically as the signal evolves. During continuous operation, incoming signals are periodically reassessed, and entropy values are recalculated for the candidate wavelets. If a change in operating conditions or fault progression alters the entropy ranking—such as when the machine shifts from stable operation to exhibiting sudden high-frequency impulses—the system updates its wavelet selection to reflect the new signal characteristics. This allows the processing unit to remain adaptive, ensuring that the representation remains optimized throughout the machine's lifecycle.

To illustrate, consider a scenario in which a rotating shaft initially operates under steady conditions with minor imbalance. In this case, a wavelet optimized for capturing periodic oscillations might be chosen. As the bearing begins to degrade and vibration transients emerge, the entropy of this wavelet's decomposition increases, while another wavelet more suitable for impulsive behavior achieves lower entropy. The system detects this shift and automatically switches to the more appropriate wavelet, enabling more precise feature extraction and fault isolation. Through this adaptive wavelet selection mechanism, the processing unit enhances the clarity and efficiency of time-frequency analysis. Unlike fixed-wavelet methods that may produce suboptimal representations under changing conditions, this approach ensures that the decomposition remains sensitive to the most diagnostically relevant signal characteristics. The result is a more accurate and responsive diagnostic pipeline capable of adapting to diverse operational environments and evolving fault signatures.

In an embodiment, the processing unit (112) is configured to generate diagnostic reports by recording the final classification outputs together with intermediate crisp outputs, fuzzy scores, and stability indices, storing said reports in a structured log file with time stamps synchronized to encoder pulses, and transmitting the log file to an external monitoring interface for review of historical motor bearing fault conditions. The process begins by capturing the final diagnostic outputs, which represent the interpreted fault state of the motor bearing at a given time. Alongside these, the system also records intermediate crisp outputs generated during de-fuzzification, as well as the fuzzy membership scores that formed the basis for these crisp values. Stability indices calculated within the verification buffer are likewise stored, as they reflect the consistency of classification results across consecutive time windows. Collectively, these data points form a multi-layered record that preserves not just the end decision but also the path taken by the classification logic.

To ensure accurate temporal correlation, each record is timestamped using synchronization signals derived from encoder pulses. The encoder provides precise positional information linked to the rotational cycle of the machine, allowing all recorded values—whether derived from vibration or rotational speed signals—to be aligned with the exact mechanical state of the system at the time of observation. For instance, a vibration impulse detected at a specific angular position of the shaft can be logged with its corresponding crisp and fuzzy scores, making it easier to trace repeated anomalies to specific rotational phases. These recorded values are stored in a structured log file organized for long-term accessibility. The structure may follow a tabular format where each row corresponds to a timestamped event, and each column captures a specific metric, such as the fuzzy membership vector, normalized crisp outputs, stability index, and final diagnostic label. This organization enables systematic querying and retrieval during later analysis. Furthermore, the log file is formatted to be compatible with external monitoring tools and maintenance dashboards, ensuring seamless integration into existing predictive maintenance workflows.

In an embodiment, the processing unit (112) is configured to maintain a temporal verification buffer that continuously stores a rolling sequence of crisp feature outputs received from the data aggregating unit (110), the buffer being organized as a first-in-first-out structure with insertion of each new crisp output at the leading edge and removal of the oldest entry, and wherein the processing unit (112) executes a frame alignment routine in which each crisp output is timestamped with rotational position markers generated by the incremental encoder (102b), the aligned outputs being compared across the buffer through a majority consensus technique that counts the frequency of recurring classifications within the buffer, and wherein the processing unit (112) computes a stability index equal to the proportion of matching classifications within the buffer, and only transmits a classification signal to the classifying unit (114) when the stability index meets or exceeds a predetermined threshold. The buffer is organized as a first-in-first-out (FIFO) structure, into which each new crisp output generated by the data aggregating unit (110) is inserted at the leading edge while the oldest entry is simultaneously removed. This rolling architecture guarantees that the buffer always contains a most-recent sequence of diagnostic evidence, enabling the system to evaluate the persistence of patterns across time rather than relying solely on single-instance outputs.

Each crisp output inserted into the buffer is timestamped with precise rotational position markers obtained from the incremental encoder (102b). This synchronization step is critical, as it ensures that diagnostic results are not just arranged in chronological order but are also linked to specific angular positions of the rotating shaft. For example, if recurring vibration anomalies are consistently detected at the same angular position, the encoder-based timestamping allows the system to identify these cyclic relationships, which are strong indicators of localized bearing defects such as outer race spalling. Once timestamped and aligned, the outputs within the buffer are analyzed using a majority consensus technique. This technique scans through the current contents of the buffer and counts the frequency of each recurring classification result. The idea is to determine whether a particular diagnostic label—such as “inner race defect” or “shaft imbalance”—is dominant across the buffer or whether the outputs are inconsistent. If the buffer contains, for instance, 8 instances of “outer race fault” and 2 instances of “normal condition,” the technique assigns dominance to the outer race classification.

In parallel, the processing unit computes a stability index, defined as the proportion of matching classifications within the buffer relative to the total number of entries. This numerical measure captures the level of consistency across the rolling window. In the previous example, the stability index would be 0.8 (8 out of 10 matching classifications). The system then compares this stability index to a predefined threshold—say, 0.75. Only if the stability index meets or exceeds this threshold does the processing unit permit transmission of the classification signal to the classifying unit (114). If the index falls below the threshold, the system defers transmission, continuing to accumulate additional outputs until greater confidence is achieved.

In an embodiment, the processing unit (112) is further configured to execute an entropy filtering procedure on crisp outputs prior to their insertion into the temporal verification buffer, the entropy filtering procedure comprising calculating an entropy value from the distribution of crisp outputs within a sliding observation window, updating the entropy value incrementally with each new output, comparing the entropy value to a dynamically maintained control threshold, tagging crisp outputs with entropy values greater than the threshold as uncertain, reducing their insertion weight in the buffer, and tagging crisp outputs with entropy values less than the threshold as certain and inserting them with full weight, and wherein the stability index of the buffer is calculated using the weighted entries to reflect both certain and uncertain classifications. The procedure begins by calculating an entropy value for each new crisp output within the context of a sliding observation window. This window contains a short history of recent crisp outputs, and the entropy measure reflects how spread out or uneven their distribution is across the available fault classes. For instance, if recent outputs are split almost evenly between “inner race defect” and “lubrication fault,” the entropy is high, signaling ambiguity. Conversely, if most outputs consistently point to “outer race defect,” entropy is low, reflecting certainty in classification. To ensure efficiency, the entropy value is updated incrementally each time a new crisp output arrives, avoiding the need to recompute the entire distribution from scratch.

The updated entropy value is compared against a control threshold, which is not fixed but dynamically maintained based on historical operating conditions and the typical distribution of crisp outputs. This adaptive threshold allows the system to account for changing machine states: for example, during startup or load transitions, a slightly higher entropy may be tolerated, while during steady operation, stricter control is applied. Crisp outputs associated with entropy values greater than the control threshold are tagged as uncertain. Instead of excluding these entries altogether, the system inserts them into the buffer with reduced weight, meaning their contribution to consensus formation and stability index calculation is deliberately minimized. On the other hand, crisp outputs with entropy values below the threshold are tagged as certain and inserted with full weight, exerting their complete influence on subsequent calculations.

When the stability index of the buffer is computed, the calculation incorporates these weights to reflect the difference between reliable and uncertain classifications. For example, if a buffer contains 7 certain entries pointing to “outer race defect” and 3 uncertain entries suggesting “normal operation,” the weighted stability index will lean heavily toward the fault condition rather than being diluted by the uncertain entries. This ensures that the system does not overreact to ambiguous signals but still preserves awareness that conflicting evidence existed.

Consider a case where a motor bearing is in the early stage of spalling. Initial impulses may activate rules inconsistently, producing alternating crisp outputs of “defect” and “normal.” The entropy filter recognizes the scattered distribution, tags the defect classifications as uncertain, and inserts them with reduced weight. As the defect progresses and the outputs stabilize around one class, entropy decreases, allowing defect-related entries to enter with full weight. This transition ensures that the buffer responds gradually and proportionally to the increasing confidence in the fault diagnosis. Through this entropy filtering mechanism, the system integrates an explicit measure of uncertainty into its verification process, ensuring that only well-supported evidence significantly influences the buffer's stability index. Unlike traditional verification methods that treat all entries equally, this weighted scheme allows the system to discriminate between reliable and ambiguous results, improving the fidelity of final classifications and reducing premature or erroneous fault signaling.

In an embodiment, the processing unit (112) is configured to apply a synchronization module that aligns the crisp feature outputs with both vibration signal frames and rotational speed segments, the synchronization module comprising calculating an index offset between frame timestamps derived from accelerometer (102a) data and rotational cycle markers derived from incremental encoder (102b) pulses, adjusting buffer insertion points according to the index offset, and reordering crisp outputs in the verification buffer to match synchronized vibration and rotation cycles before stability index calculation. The synchronization module calculates an index offset between the timestamps of the vibration frames and the cycle markers derived from encoder pulses. This involves cross-referencing the frame indices generated during vibration preprocessing with the angular position markers produced by the encoder. For example, if an accelerometer frame is timestamped at 10.002 seconds and the corresponding encoder marker for the same shaft position is at 10.000 seconds, the synchronization module determines an offset of 2 milliseconds. This offset is continuously updated as signals stream in, allowing the system to track and correct even minor drifts over time.

Once the index offset is determined, the processing unit adjusts the insertion points of crisp feature outputs into the verification buffer. Rather than placing crisp outputs immediately upon their generation, the system shifts their insertion position according to the calculated offset, ensuring that vibration-derived outputs are aligned with the correct rotational segment. For instance, if a defect impulse in the vibration signal occurs consistently at a shaft angle of 90 degrees, the synchronization module guarantees that the corresponding crisp classification is paired with the rotational cycle marker for 90 degrees, even if raw timestamps differed slightly. After insertion adjustments, the synchronization module also reorders crisp outputs within the buffer to enforce alignment between vibration frames and rotational segments. This reordering step ensures that both modalities are evaluated in parallel across the same machine cycles before stability index calculation. If, for example, three vibration frames were delayed relative to encoder markers, the system reorders them so that both signal types contribute evidence for the same sequence of rotational cycles.

This synchronized arrangement strengthens the integrity of the stability index calculation, as it ensures that consensus is built on temporally and mechanically consistent evidence. For instance, if vibration outputs consistently classify “outer race defect” at a specific shaft angle and rotational speed outputs confirm torque ripple at the same angle, the synchronized buffer reflects this joint evidence with high confidence. In contrast, without synchronization, the system might mistakenly associate the vibration impulse with a different rotational cycle, diluting or even obscuring the true relationship between the signals. By aligning crisp outputs to both vibration frames and rotational cycles, this embodiment ensures that diagnostic classifications are cycle-accurate, providing a stronger connection between the observed features and the underlying physical mechanisms of the machine. Compared with systems that treat vibration and speed streams independently or simply align them by raw time stamps, this synchronization mechanism improves diagnostic precision, particularly for defects that manifest cyclically at specific shaft positions.

In an embodiment, the processing unit (112) is further configured to maintain a dual-layer buffer structure comprising a primary short-term buffer that stores crisp outputs across a limited number of recent windows and a secondary long-term buffer that stores consensus outputs from the primary buffer over extended operational intervals, and wherein the processing unit (112) compares classification results across the primary and secondary buffers, calculates a divergence index measuring consistency between short-term and long-term consensus values, and restricts progression to the classifying unit (114) if the divergence index exceeds a preset tolerance limit. The dual-layer buffer consists of two distinct storage structures. The primary short-term buffer holds crisp outputs collected across a limited number of recent analysis windows, typically spanning a few seconds or cycles of machine operation. This buffer captures the most current diagnostic information, including short-lived anomalies that may or may not evolve into persistent conditions. The secondary long-term buffer, by contrast, stores consensus outputs derived from the primary buffer but aggregated over extended intervals. For instance, every time the short-term buffer reaches stability and produces a majority classification, this consensus value is appended to the long-term buffer. As a result, the secondary buffer builds a record of classifications that reflect persistent patterns rather than transient deviations.

The processing unit then compares the classifications in the short-term and long-term buffers to evaluate their consistency. A divergence index is computed to measure the degree of mismatch between the consensus emerging from recent data and the consensus accumulated over longer operational intervals. The divergence index may be defined as the proportion of disagreement between the two buffers relative to the total number of classifications compared. For example, if the short-term buffer repeatedly identifies “outer race defect” while the long-term buffer trends toward “imbalance,” the divergence index increases, signaling an inconsistency. When the divergence index exceeds a predefined tolerance limit, the system restricts the progression of results to the classifying unit (114). This restriction prevents premature or unstable classifications from being recorded as final diagnostic outputs. Instead, the processing unit continues to accumulate more data until either the short-term results converge toward the long-term pattern or sufficient evidence emerges that the machine has transitioned into a new state. For instance, if a temporary operational anomaly, such as a load surge, triggers conflicting outputs in the short-term buffer, the divergence index will temporarily rise, holding back classification progression. Once the anomaly subsides, the short-term and long-term buffers realign, reducing the divergence index and allowing classification to resume.

This layered verification process ensures that diagnostic signals represent not just recent conditions but also their consistency with historical evidence. It prevents sudden environmental disturbances, sensor glitches, or operational fluctuations from causing spurious fault declarations. By requiring alignment between immediate and extended data perspectives, the dual-buffer system strengthens diagnostic stability and accuracy. Compared with conventional single-buffer approaches that rely solely on short-term data, this embodiment provides an additional safeguard by embedding historical context into real-time decision-making, making it particularly valuable for long-duration machine monitoring in industrial environments.

In an embodiment, the processing unit (112) is further configured to apply an anomaly detection filter to crisp outputs prior to classification, the anomaly detection filter comprising computing deviation values by comparing current crisp outputs against a rolling baseline average, updating the baseline average incrementally with each new output, and flagging crisp outputs with deviations exceeding a deviation threshold as anomalies, such anomalies being stored in a separate anomaly register and excluded from stability index calculations. The anomaly detection procedure begins by maintaining a rolling baseline average of crisp outputs over a defined observation window. This baseline reflects the recent “normal” state of the system as understood by the classifier, and it updates incrementally with each new crisp output. For example, if the system consistently classifies the machine state as “outer race defect” over several cycles, the baseline average converges around that classification, providing a stable reference point. The incremental update ensures that the baseline adapts gradually to evolving conditions while avoiding abrupt changes that could mask emerging anomalies.

When a new crisp output arrives, the processing unit computes its deviation value by comparing it against the rolling baseline. This deviation may be calculated as the difference between the new output's encoded value (or probability distribution if available) and the baseline average. If the deviation exceeds a predefined threshold, the crisp output is flagged as anomalous. For instance, if the machine has been consistently classified as “healthy” for several minutes and a sudden single-cycle classification of “catastrophic bearing failure” appears, the deviation filter immediately identifies it as an anomaly rather than accepting it as a reliable indicator of machine state. Flagged anomalies are stored in a dedicated anomaly register, separate from the main verification buffer. This ensures that the system retains a record of unusual events for later inspection without allowing them to distort the stability index calculation. The anomaly register can be periodically reviewed by maintenance engineers to assess whether these deviations represent early signs of rare fault types or simply noise-induced artifacts. Meanwhile, the stability index—which governs whether outputs are forwarded to the classifying unit (114)—is computed exclusively from non-anomalous crisp outputs. By excluding flagged entries, the stability index reflects only consistent, trustworthy evidence, ensuring that final classifications are not skewed by outliers. This embodiment strengthens the system's diagnostic capability by introducing a discriminative layer that separates genuine long-term trends from spurious or isolated irregularities. In contrast to conventional systems that either discard outliers entirely or naively include them in stability calculations, this approach preserves anomalies in a separate register for secondary analysis while shielding the primary decision-making process from their disruptive influence. This dual treatment of anomalies ensures both reliability in real-time classification and traceability for deeper fault analysis.

In an embodiment, the processing unit (112) is configured to maintain a hierarchical memory structure for storing crisp outputs, the hierarchical memory structure comprising a first-tier memory for short-term storage of raw crisp outputs, a second-tier memory for aggregated consensus results, and a third-tier archival memory for storing long-term classification histories together with entropy metrics and stability indices, and wherein the processing unit (112) executes periodic consistency checks by comparing results across tiers to ensure continuity of stored diagnostic data.

The first-tier memory acts as a buffer for raw crisp outputs generated directly from the data aggregating unit (110). This storage is highly dynamic, retaining outputs over a relatively short window—such as several seconds or machine cycles. Its purpose is to capture the most immediate diagnostic evidence, which is particularly useful for detecting rapid changes or transient anomalies. For example, a sudden rise in crisp outputs indicating “imbalance” will first appear in this short-term memory, providing immediate visibility into emerging behaviors.

The second-tier memory stores aggregated consensus results derived from the short-term outputs. Rather than recording each raw crisp output, this layer compresses the information into summary classifications that represent stable decisions over intermediate intervals. For instance, if the short-term memory repeatedly identifies “outer race defect” over 100 consecutive windows, the second-tier memory will store this aggregated consensus rather than all 100 raw entries. This tier provides a reliable mid-range perspective that filters out short-term noise while remaining responsive to developing fault trends.

The third-tier archival memory is designed for long-term preservation of diagnostic history. Unlike the other tiers, it not only stores consensus classifications but also retains supporting metadata such as entropy metrics and stability indices. This ensures that each recorded diagnosis is accompanied by contextual measures of uncertainty and confidence. For example, an archival entry may record that during a given week the machine was predominantly classified as “inner race defect,” with an average stability index of 0.92 and entropy levels steadily declining. Such detailed archival records are invaluable for predictive maintenance planning, post-failure analysis, and verifying the consistency of the system's operation over months or years.

To maintain coherence across these tiers, the processing unit periodically executes consistency checks. These checks compare the results stored in the first-tier, second-tier, and third-tier memories to ensure that the system's short-term outputs, aggregated consensus, and long-term records align with one another. If discrepancies are detected—such as a second-tier consensus of “normal operation” conflicting with a first-tier majority of “outer race defect”—the system flags the inconsistency for review and may delay final classification until further evidence resolves the conflict. This mechanism ensures continuity of stored diagnostic data and prevents contradictions from propagating into historical logs. A practical scenario demonstrates the utility of this hierarchical structure. Suppose a bearing begins to develop a subtle fault that intermittently appears in raw crisp outputs but does not yet dominate. The first-tier memory captures these fluctuations. Over time, as the fault grows more consistent, the second-tier memory records aggregated consensus reflecting the developing pattern. Eventually, the third-tier archival memory preserves the full history of fault progression, complete with confidence metrics. Maintenance personnel reviewing this record can trace the defect's evolution from its earliest irregular hints to its confirmed long-term diagnosis, enabling informed intervention planning.

In an embodiment, the classifying unit (114) is configured to finalize diagnostic labels using a two-stage validation process, the two-stage process comprising a first validation stage in which crisp outputs from the processing unit (112) are aggregated into partially overlapping temporal windows, each temporal window being processed through majority voting to yield a local classification result, and a second validation stage in which a probability distribution is constructed across the local classification results, an entropy measure is computed from the distribution, and the diagnostic label is finalized only when the entropy measure falls below a predefined limit, the finalized diagnostic label being stored as the motor bearing fault state.

The first validation stage operates on crisp outputs generated by the processing unit (112). These outputs are not evaluated in isolation but are aggregated into partially overlapping temporal windows. Each window spans a defined sequence of crisp outputs, with an overlap that ensures continuity between successive windows and prevents information loss at the boundaries. Within each window, a majority voting scheme is applied: the classification label that appears most frequently across the window is selected as the local classification result. This step filters out sporadic outliers and highlights the dominant trend within short-term sequences. For example, if a window contains 7 outputs of “outer race defect” and 3 outputs of “normal,” the majority vote yields “outer race defect” as the local classification. By overlapping windows, the system ensures that abrupt changes are smoothly tracked while preserving the persistence of valid fault signals.

The second validation stage introduces a probabilistic assessment to further test the consistency of these local classifications. Once a set of local results has been produced, the system constructs a probability distribution representing the frequency of each diagnostic label across these results. From this distribution, an entropy measure is calculated to quantify the level of uncertainty in the classification pattern. High entropy indicates that multiple fault labels are competing with similar probability, while low entropy reflects a dominant, well-defined classification. The classifying unit applies a decision rule that finalizes a diagnostic label only when the computed entropy falls below a predefined limit. This ensures that the final label corresponds to a stable and highly probable classification, rather than one derived from scattered or conflicting evidence. For example, if the distribution across local classifications is 80% “inner race defect” and 20% “normal,” the entropy is low, and the system confidently finalizes “inner race defect” as the diagnostic label. Conversely, if the distribution is split 50-50 between two competing labels, entropy remains high, and the system withholds finalization until further data resolves the uncertainty.

Once finalized, the diagnostic label is stored as the motor bearing's fault state, forming the official record for maintenance and monitoring systems. This ensures that only well-validated results are logged, providing operators with reliable and actionable fault information. To illustrate, consider a machine in which early bearing degradation produces inconsistent outputs due to low signal-to-noise ratio. The first validation stage filters these results, producing local classifications that begin to lean toward “outer race defect.” However, the entropy remains high due to competing “normal” results, and the system delays finalization. As the fault progresses and evidence accumulates, the distribution converges, entropy drops, and the system finalizes the fault label. This delayed but confident confirmation prevents false alarms while still ensuring timely fault recognition.

In an embodiment, the classifying unit (114) is configured to execute a redundancy verification operation by comparing diagnostic labels generated from vibration-derived features with diagnostic labels generated independently from rotational speed-derived features, the redundancy verification operation comprising isolating the crisp outputs of the vibration signal path and rotational speed signal path prior to aggregation, computing independent classifications for each path, and passing the final diagnostic label only when both independent classifications match, while in case of mismatch, deferring classification and requesting recalibration of feature extraction parameters.

The redundancy verification process begins by isolating the crisp outputs generated along the two distinct feature extraction paths—one for vibration signals and the other for rotational speed signals. Rather than aggregating them immediately into a combined result, the system treats each path as an independent diagnostic channel. The processing unit (112) ensures that these outputs have already been temporally aligned, so the classifying unit can evaluate them side by side across the same operational cycles. For each analysis interval, the classifying unit computes independent classifications for the vibration path and the rotational path. For example, if vibration features highlight repeated high-frequency impacts, the vibration path may classify the condition as an “outer race defect.” Simultaneously, if the rotational speed path detects corresponding torque ripples at matching shaft positions, it may also classify the same interval as “outer race defect.” When such agreement occurs, the system accepts the classification as valid and passes it forward as the final diagnostic label.

However, in cases where the two paths yield mismatched classifications, the system defers finalization. For instance, vibration features may suggest “shaft imbalance” while rotational speed features classify the same data as “normal operation.” Such discrepancies indicate either a transient inconsistency in the data or a misalignment in the way features are being extracted. Rather than risking an incorrect fault declaration, the classifying unit delays confirmation and triggers a recalibration process for the feature extraction unit (106). This recalibration may involve adjusting convolution kernel parameters, reassessing frame lengths, or rebalancing fuzzy rule weights to improve coherence between the two signal domains. A practical example illustrates the value of this redundancy mechanism. Suppose a machine is operating under variable load conditions that intermittently distort vibration signals. In such a case, vibration features alone might falsely suggest a developing fault, while rotational speed features remain stable. By requiring both channels to agree, the system prevents a false alarm. Conversely, if a true defect emerges, both vibration and speed signals eventually converge to the same classification, ensuring that the final diagnostic label reflects a real and consistent machine condition.

This redundancy verification step advances diagnostic robustness by combining multimodal evidence into a cross-checking mechanism. Conventional systems that rely on a single modality risk overreacting to noise or missing fault signatures that manifest differently across signal types. By enforcing agreement between vibration and rotational domains and initiating recalibration in the event of persistent mismatch, this embodiment ensures that final diagnostic labels are grounded in consistent physical evidence and that the feature extraction pipeline remains tuned to evolving machine behavior.

In an embodiment, the classifying unit (114) further comprises a hierarchical decision fusion module configured to combine classifications across multiple operational states of the motor bearing, the decision fusion module comprising constructing a classification vector for each operational state from its associated crisp outputs, arranging the vectors into a decision matrix, calculating inter-vector similarity scores, and producing a fused classification decision by applying weighted voting across the decision matrix rows, with the weights assigned proportional to the similarity scores of the respective vectors. A defect may appear more prominently during one state (e.g., load-induced stress amplifying vibration impulses) while remaining subtle or partially masked in another. By fusing classifications across these operational states, the system ensures that final diagnostic labels are not biased toward isolated conditions but instead represent a consistent interpretation across the machine's full operating profile.

The fusion process begins by constructing a classification vector for each operational state. These vectors are derived from crisp outputs associated with the respective state and encode the relative strength of different fault hypotheses. For instance, under steady-state operation, the classification vector may indicate high support for “outer race defect” and low support for “imbalance,” while during acceleration, the same defect may express itself differently, leading to a slightly different distribution of crisp outputs. Once classification vectors are generated for all operational states, the system arranges them into a decision matrix, where each row corresponds to an operational state and each column corresponds to a potential diagnostic label. This structured matrix allows the classifying unit to analyze how fault indications are distributed across different operating contexts. To evaluate consistency, the module calculates inter-vector similarity scores between the rows. These scores quantify how closely the classifications from different states align with one another. For example, if vectors from both steady-state and deceleration strongly emphasize “outer race defect,” their similarity score will be high, while a mismatch between “imbalance” and “defect” classifications across states results in lower similarity.

The final fused classification decision is generated by applying weighted voting across the rows of the decision matrix. Instead of assigning equal weight to each state, the system uses the similarity scores as proportional weights. This ensures that states showing higher agreement exert stronger influence in the final decision. For instance, if three operational states converge on “inner race defect” with high similarity, while one state under startup conditions produces conflicting results, the weighted voting mechanism privileges the majority consensus and reduces the impact of the outlier. This embodiment improves diagnostic dependability by synthesizing evidence from multiple operating regimes into a single, well-supported conclusion. Unlike conventional classifiers that may finalize decisions based solely on one operating state, this hierarchical fusion mechanism ensures that fault labels represent consistent patterns across diverse machine conditions. It provides maintenance engineers with diagnostic outputs that are not only accurate in a single moment but validated across the full spectrum of operational behavior, making the system particularly effective for continuous industrial monitoring.

In an embodiment, the classifying unit (114) is further configured to apply a state transition verification mechanism, the mechanism comprising recording the sequence of diagnostic labels over time, constructing a state transition matrix from the recorded sequence, comparing the current state transition against predefined permissible transitions, and withholding final classification output when the detected transition does not match any permissible pattern, the withheld output being queued until additional verification cycles are completed. Mechanical systems, such as motor bearings, typically pass through recognizable sequences of states as they degrade—from healthy operation to early wear, then to moderate damage, and ultimately to severe failure. However, noise, transient disturbances, or data misinterpretations can sometimes cause classification outputs to jump abruptly between unrelated states, such as from “healthy” directly to “catastrophic failure,” without passing through intermediate conditions. Such discontinuities reduce confidence in automated diagnostics. The state transition verification mechanism addresses this by validating every newly generated diagnostic label against a library of permissible transition pathways before releasing it as a final output.

The process begins with the continuous recording of diagnostic labels over time, creating a temporal sequence of machine states. From this sequence, the classifying unit constructs a state transition matrix that reflects the order and frequency of observed transitions. Each entry in the matrix represents the probability of moving from one diagnostic state to another. For example, a transition from “healthy” to “incipient inner race fault” may be expected and permissible, while a direct transition from “healthy” to “severe lubrication failure” without prior intermediate signs would be considered unlikely or impermissible.

When a new diagnostic label is generated, the system compares the proposed transition against the predefined permissible patterns embedded in the state transition matrix. These patterns are based on domain knowledge, empirical data, or manufacturer-specified fault progression models. If the detected transition matches one of the permissible pathways, the label is accepted and released as the final classification output. Conversely, if the transition is inconsistent with expected behavior, the system withholds the classification output rather than transmitting it directly.

Withheld outputs are placed in a verification queue, where they remain until additional cycles of classification are processed. If subsequent outputs provide supporting evidence that the transition was valid—such as consistent repetition of the new fault label—the system may update the transition matrix dynamically and confirm the label. Otherwise, the anomalous transition is discarded as a likely false reading. By enforcing continuity and logical progression in diagnostic outputs, this embodiment prevents false alarms and improves interpretability. Operators and maintenance teams receive fault reports that reflect realistic fault development rather than erratic, noise-driven jumps. Compared with conventional classifiers that assess each cycle in isolation, this transition verification framework embeds a temporal memory of permissible state changes, yielding diagnostic outputs that are both accurate and faithful to the physical degradation pathways of motor bearings.

In an embodiment, the classifying unit (114) is further configured to implement a multi-resolution decision analysis, the analysis comprising processing diagnostic labels at multiple aggregation levels including frame-level, window-level, and cycle-level, arranging results into a hierarchical decision structure, applying weighted voting across the hierarchy, and generating the final motor bearing diagnostic state based on aggregated decisions from all levels of the hierarchy. Fault signatures in rotating machinery are not always consistent across every scale of observation: a localized impulse may appear clearly at the frame level but become diluted when aggregated over longer windows, while recurring patterns at the cycle level may not be visible in short-term frames due to noise. By analyzing diagnostic outputs across multiple resolutions and combining them hierarchically, the system balances sensitivity to transient signals with stability in long-term trends.

The process begins with frame-level classification, where diagnostic labels are generated from the shortest analysis segments of the vibration and rotational speed signals. Frame-level results are highly responsive to rapid changes, such as a sudden impact caused by localized spalling or debris entering the bearing. These classifications provide early warning cues but can also be affected by short-lived disturbances. The next layer, window-level aggregation, groups several consecutive frames into overlapping windows and applies majority voting to produce a more stable classification. This level filters out isolated misclassifications while retaining responsiveness to evolving fault trends. Finally, at the cycle-level, classifications are aggregated over entire machine rotation cycles, aligning results with encoder markers to capture periodic fault signatures such as harmonics associated with misalignment or imbalance. Once diagnostic labels are produced at frame, window, and cycle levels, they are arranged into a hierarchical decision structure. This structure provides a comparative view of how the same data is interpreted across resolutions. The system then applies a weighted voting mechanism across the hierarchy, assigning weights based on the reliability of each level. For example, cycle-level results, being less sensitive to noise and aligned with mechanical periodicity, may receive higher weight, while frame-level results contribute early sensitivity but lower voting power due to their higher variance. The weighted voting process ensures that no single resolution dominates the decision, but that all contribute proportionally to the final outcome.

The aggregated decision produced by this process becomes the final diagnostic state of the motor bearing. For example, if frame-level classifications alternate between “normal” and “outer race defect,” window-level aggregation stabilizes around “outer race defect,” and cycle-level classification confirms the same, the weighted voting process yields a final state of “outer race defect.” Conversely, if frame-level labels sporadically suggest “imbalance” but both window-level and cycle-level consistently indicate “normal,” the hierarchy suppresses the false signal and confirms the healthy state.

This multi-resolution analysis advances diagnostic reliability by explicitly considering information across different scales of observation. It reduces false alarms that would arise from relying solely on short-term frames while avoiding delays in fault recognition that could occur if only long-term cycles were considered. By synthesizing these perspectives into a unified diagnostic state, the system provides operators with results that are both sensitive to early-stage defects and stable enough for confident decision-making.

In an embodiment, the signal collecting unit (102) is further configured to execute synchronous sampling of vibration and rotational speed signals, the synchronous sampling comprising generating synchronization markers based on encoder pulses, sampling vibration data at each synchronization marker, constructing a combined signal record comprising time-aligned vibration and rotation samples, and transmitting the combined record to the data segmenting unit (104) for subsequent conversion into time-frequency segments. If these signals are recorded independently, even small timing differences can cause significant misalignment, making it difficult to establish whether a vibration impulse occurred at a specific shaft angle or at a random moment. By enforcing synchronous sampling, the system ensures that every vibration data point has a direct temporal and positional reference to the machine's rotation cycle.

The synchronization begins with the incremental encoder (102b) generating a sequence of pulses as the shaft rotates. These pulses act as precise markers of rotational position. For each encoder pulse, the signal collecting unit triggers the sampling of vibration data from the accelerometer (102a). This creates a structured pairing where vibration values are captured in lockstep with rotational markers, ensuring that both signals reference the same physical instant. For example, if the encoder emits a pulse every 1°of shaft rotation, the system samples vibration data exactly at these angular increments, creating a one-to-one correspondence between vibration magnitude and shaft position.

Once collected, the system constructs a combined signal record in which each entry contains both the vibration measurement and its corresponding rotational reference. This record is not just a time-aligned dataset but also a spatially aligned dataset tied directly to the rotational cycle of the machine. Such a structure is invaluable for identifying defects that manifest cyclically, such as bearing spalls that cause impacts at the same shaft angle each revolution or gear tooth faults that repeat at specific positions. The combined record is then transmitted to the data segmenting unit (104), where it is transformed into time-frequency segments for further processing. Because the signals are already synchronized, subsequent segmentation and transformation preserve the rotational context of the vibration data, allowing the feature extraction and classification pipeline to detect patterns tied to specific machine geometries. For instance, if a vibration spike consistently occurs when the encoder marker indicates a shaft angle of 120°, the system can reliably attribute this to a localized fault, rather than treating it as a random transient.

By synchronizing vibration and rotational speed signals at the point of acquisition, this embodiment creates a high-integrity dataset that preserves both temporal and mechanical context. Unlike conventional systems that align signals retrospectively through interpolation, this approach ensures native synchronization at the hardware level, reducing processing complexity downstream and improving the fidelity of diagnostic interpretation.

In an embodiment, the signal collecting unit (102) is further configured to execute a multi-sensor calibration sequence prior to signal acquisition, the calibration sequence comprising generating controlled test pulses from the incremental encoder (102b), simultaneously capturing vibration responses from the accelerometer (102a), calculating phase offsets between encoder pulses and accelerometer signals, and applying corrective phase alignment coefficients to subsequent vibration signal recordings, such that all acquired signals are phase-synchronized before being forwarded to the data segmenting unit (104).

In this embodiment, the signal collecting unit (102) is enhanced with a multi-sensor calibration sequence that is carried out prior to normal signal acquisition, ensuring that all sensors involved in the monitoring process operate in phase alignment. When multiple sensors such as the incremental encoder (102b) and accelerometer (102a) are used together, even small phase offsets caused by hardware latency, transmission delay, or sampling jitter can distort the relationship between rotational markers and vibration responses. If not corrected, these misalignments can lead to diagnostic errors, such as falsely attributing a vibration impulse to the wrong shaft angle or failing to recognize that periodic disturbances in vibration are synchronized with encoder pulses. The calibration sequence corrects for these discrepancies so that subsequent data acquisition is phase-coherent.

The calibration begins by generating controlled test pulses from the incremental encoder (102b). These test pulses are precisely timed and serve as reference events against which the vibration sensor's response can be compared. Simultaneously, the accelerometer (102a) records vibration data while the encoder pulses are generated. Because the test pulses represent an idealized rotational reference, the accelerometer's response is expected to show measurable changes at the same instants, though in practice, delays often occur due to sensor hardware or data acquisition circuitry.

Once both signals are collected, the system calculates phase offsets by comparing the timing of the encoder pulses with the corresponding accelerometer responses. This involves cross-correlation or phase angle computation between the two signal sets. For example, if an encoder pulse is registered at time t=1.000t=1.000 seconds but the accelerometer's corresponding peak response occurs at t=1.002t=1.002 seconds, a phase offset of 2 milliseconds is identified. These offsets may vary across operating frequencies or sensor channels, so the calibration is performed over multiple cycles to ensure accurate estimation.

After determining the phase offsets, the system generates corrective phase alignment coefficients. These coefficients represent the adjustment factors needed to synchronize the accelerometer signals with the encoder pulses. In practice, this may involve applying fractional time shifts to the vibration signal or adjusting the sampling trigger to compensate for the measured delay. Once applied, these corrections ensure that every vibration sample is precisely aligned with the encoder's rotational markers, creating a phase-synchronized dataset.

Following calibration, all acquired signals—whether from vibration or rotational sensors—are inherently phase-aligned before being forwarded to the data segmenting unit (104). This alignment is crucial for accurately constructing time-frequency segments that reflect true machine dynamics. For example, in a bearing with a localized spall, the resulting vibration impacts occur at the same angular position each rotation. Without calibration, phase offsets could shift the apparent position of these impacts, leading to diagnostic confusion. With calibration, the impacts align consistently with encoder pulses, allowing the system to pinpoint the defect's location and severity more precisely. By embedding a pre-acquisition calibration sequence, this embodiment prevents systematic timing errors from propagating through the diagnostic pipeline. Conventional systems often attempt to correct phase offsets retrospectively through post-processing, which can be computationally expensive and prone to residual error. In contrast, this proactive calibration ensures that all signals entering the pipeline are already phase-synchronized, improving diagnostic accuracy, reducing false interpretations, and ensuring reliable fault localization from the very beginning of data processing.

In an embodiment, the signal processing unit (116) is configured to apply a Hanning window function to each segment by calculating overlapping window functions, multiplying each signal segment by the Hanning coefficients to taper boundary amplitudes, recombining adjacent windowed segments to minimize discontinuities, and verifying distortion reduction by performing spectral analysis on recombined segments to confirm suppression of boundary artifacts before feature extraction. When raw signals are divided into finite-length segments for time-frequency analysis, sharp edges at the segment boundaries can introduce artificial discontinuities. These discontinuities, when processed through Fourier or wavelet transforms, manifest as spectral leakage—false frequency components that obscure the true signal characteristics. To address this, the system integrates a Hanning windowing process that smooths the segment boundaries and ensures that only genuine frequency content contributes to downstream feature extraction.

The procedure begins by calculating overlapping window functions across consecutive signal segments. Each window is shaped by Hanning coefficients, which follow a raised cosine profile that gradually attenuates the signal amplitude toward zero at the edges while preserving full amplitude in the central portion of the segment. When each signal segment is multiplied by these coefficients, the abrupt transitions at the boundaries are tapered smoothly, reducing discontinuity effects. For example, if a segment captures part of a sinusoidal vibration waveform, the raw cut at the edges may introduce sharp jumps, but after applying the Hanning window, these edges gently decay, making the transition into and out of the segment more natural. Once individual segments are windowed, adjacent segments are recombined with overlap to reconstruct the signal continuity across time. The overlapping ensures that energy lost near the edges of one segment is recovered from the central portion of the neighboring segment. This overlap-add process guarantees that the entire signal timeline is represented without gaps while still benefiting from boundary tapering. For instance, if 50% overlap is used, each data point in the original signal contributes to more than one windowed segment, improving representation accuracy.

After recombination, the signal processing unit verifies the effectiveness of windowing by performing spectral analysis on the recombined data. This step confirms that artificial boundary artifacts have been suppressed and that the spectral energy distribution reflects only the true physical content of the signal. For example, without windowing, a pure vibration tone at 1 kHz might produce leakage artifacts spreading into neighboring frequency bins. With Hanning windowing, the spectral energy remains tightly concentrated around 1 kHz, confirming that leakage has been minimized.

In an embodiment, the data segmenting unit (104) is configured to apply a complex wavelet transform by selecting mother wavelets from a candidate library, decomposing the vibration and rotational speed signals into multiple resolution levels, constructing a two-dimensional time-frequency matrix for each signal, and aligning the matrices to produce a synchronized two-dimensional representation, the synchronized representation being forwarded to the feature extracting unit (106) for convolution-based analysis. The process begins with the selection of mother wavelets from a candidate library. This library may include commonly used wavelets such as Morlet, Coiflet, Daubechies, and Symlet families, each of which is suited to particular signal characteristics. The selection can be adaptive, as described earlier in the entropy-based wavelet evaluation, or fixed according to prior calibration. For example, if the vibration signal is dominated by sharp transients typical of early bearing defects, a Morlet wavelet may be chosen for its ability to localize impulsive events. If rotational speed signals exhibit smoother torque fluctuations, a Coiflet wavelet may be better suited.

Once the mother wavelet is selected, the vibration and rotational speed signals are decomposed into multiple resolution levels. This multi-resolution analysis allows the system to capture fine details at high-frequency bands while simultaneously representing slower, large-scale trends at lower-frequency bands. For instance, the high-frequency decomposition may reveal minute vibration spikes caused by microscopic surface pitting, while the low-frequency decomposition captures periodic modulations associated with shaft imbalance or misalignment. The results of this decomposition are arranged into a two-dimensional time-frequency matrix for each signal, where one axis represents time (or rotational cycles) and the other axis represents frequency bands. Each entry in the matrix contains the magnitude (and phase, if required) of the wavelet coefficients at that specific time and frequency. This representation provides a detailed map of how frequency content evolves over time for both vibration and rotational speed data streams.

To ensure coherence between the two modalities, the data segmenting unit aligns the time-frequency matrices from the vibration and rotational speed signals. This alignment is achieved using synchronization markers derived from encoder pulses, ensuring that events in the vibration domain are matched with corresponding events in the rotational domain. For example, a vibration impulse occurring at a shaft angle of 120° is aligned with the rotational cycle marker at the same angular position. As a result, the two matrices form a synchronized representation that directly links vibration activity with shaft dynamics.

The aligned two-dimensional representation is then forwarded to the feature extracting unit (106), where convolution-based analysis is applied. With both vibration and rotational speed signals represented in synchronized time-frequency matrices, convolutional kernels can operate across the two domains in parallel, identifying correlated structures such as impulses that coincide with rotational irregularities. This integrated representation significantly enhances the classifier's ability to distinguish between genuine fault signatures and unrelated noise. For example, consider a bearing with an outer race defect. In the vibration matrix, the defect manifests as periodic high-frequency bursts, while in the rotational speed matrix, it may appear as slight but consistent cycle-to-cycle slowdowns. By aligning and representing these patterns together in synchronized time-frequency space, the system ensures that the feature extraction process captures the dual evidence of the defect. Compared to conventional one-dimensional segmentation approaches, this embodiment provides a richer and more interpretable signal representation that combines temporal precision with frequency resolution. By aligning the vibration and rotational matrices, the system strengthens diagnostic accuracy, making it more resilient to noise and more capable of identifying fault signatures tied to specific machine cycles.

In an embodiment, the data segmenting unit (104) is further configured to implement an adaptive overlap management routine, said routine comprising measuring the instantaneous rate of frequency change within each segment of the vibration and rotational speed signals, assigning higher overlap percentages for segments with rapid frequency variation and lower overlap percentages for segments with relatively uniform content, and dynamically updating overlap values as new signal segments arrive, wherein the adjusted overlap segments are reconstructed into a continuous time-frequency plane for subsequent analysis. Traditional segmentation methods often use a fixed overlap ratio—such as 50%—to preserve continuity between segments. While effective in some cases, fixed overlaps can either introduce redundancy when the signal is stable or cause information loss when the signal undergoes rapid changes. By adapting the overlap percentage to the instantaneous frequency dynamics of the signal, the system ensures that critical transitions are captured with sufficient resolution while computational efficiency is maintained during stable conditions.

The routine begins by measuring the instantaneous rate of frequency change within each incoming segment. This can be achieved by computing the derivative of the dominant frequency component or by evaluating spectral centroids across short sub-windows. For example, if a vibration segment shows a sharp upward drift in dominant frequency caused by resonance excitation during a fault event, the rate of frequency change is classified as high. Conversely, if the rotational speed signal maintains steady periodicity with minimal variation, the rate of change is classified as low.

Based on this measurement, the overlap percentage for subsequent segmentation is adaptively assigned. When rapid frequency variation is detected, the system increases the overlap percentage so that consecutive segments share more data points. This ensures that transient events—such as short bursts of high-frequency impulses from a bearing crack—are not lost at the segment boundaries but are instead captured across multiple segments, allowing them to be more reliably detected in the time-frequency plane. For example, a segment with high-frequency modulation may receive a 75% overlap instead of the default 50%. On the other hand, when the signal content is relatively uniform, such as during steady-state operation with minimal anomalies, the overlap percentage is reduced—perhaps to 25%—which decreases redundant computation while still maintaining signal continuity.

The overlap percentages are not static but dynamically updated as new signal segments arrive. This allows the system to continuously adapt to evolving machine conditions in real time. If the machine transitions from stable operation to an irregular regime—such as during load fluctuations or at the onset of fault development—the overlap percentage automatically increases, ensuring detailed capture of the emerging dynamics. When stability returns, the system relaxes back to lower overlap, optimizing computational resources. The adjusted segments are then reconstructed into a continuous time-frequency plane, with the overlapping portions merged smoothly to avoid discontinuities. This reconstructed plane becomes the input for further convolution-based feature extraction. Because segments with rapid variation have denser overlap, the resulting plane emphasizes the temporal fidelity of fault-related events, while uniform segments remain compact and efficient.

For instance, in a scenario where a motor bearing begins to develop outer race pitting, the vibration signals may initially be uniform, requiring minimal overlap. As the defect progresses, high-frequency impulses appear irregularly, increasing the measured rate of frequency change. The adaptive routine responds by expanding the overlap, ensuring that these transient events are captured across multiple segments in the time-frequency plane. As a result, the feature extracting unit (106) is supplied with a detailed and continuous representation of the evolving fault, enabling early and accurate detection.

In an embodiment, all functional units and modules described herein, including the signal collecting unit, signal processing unit, data segmenting unit, feature extracting unit, fuzzy-based classification unit, data aggregating unit, processing unit, and classifying unit, are implemented using a combination of tangible hardware elements and programmed control logic executed on one or more computing processors. The hardware implementation may include sensors such as accelerometers and incremental encoders for physical data collection, digital signal processors (DSPs) or field-programmable gate arrays (FPGAs) for pre-processing and time-frequency conversion, and embedded processors, microcontrollers, or graphical processing units (GPUs) for convolutional and fuzzy inference computations. Each unit is supported by dedicated memory elements storing executable instructions, calibration parameters, and lookup tables necessary for the described functions. The signal collecting and processing units operate as integrated data acquisition and conditioning subsystems executing synchronous sampling, filtering, and windowing routines; the data segmenting unit executes programmed algorithms for complex wavelet transformation and adaptive segment overlap management; the feature extracting unit comprises convolutional logic configured to perform SOF-CNN operations using parameterized kernels and dynamic reassignment procedures; the fuzzy-based classification unit implements numerical routines for hierarchical fuzzification, rule activation, conflict resolution, feedback adaptation, and temporal smoothing; the data aggregating unit performs weighted normalization and de-fuzzification through stored mathematical procedures; the processing unit executes entropy-based selection, stability verification, and anomaly filtering routines using buffered data structures; and the classifying unit performs decision fusion and validation using probabilistic and hierarchical aggregation models. All modules communicate through a digital interface or shared memory bus and operate under the control of a central software framework stored in non-transitory memory.

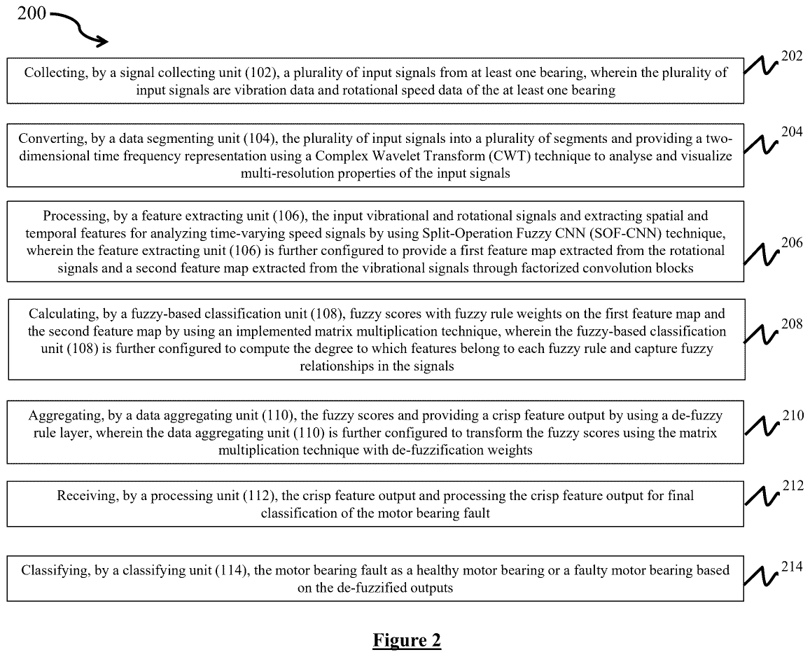

Referring to FIG. 2, a flow diagram of a convolution-based dual-input fuzzy method (200) for diagnosing a motor bearing fault is illustrated.

At Step (202), the method (200) includes collecting, by a signal collecting unit (102), a plurality of input signals from at least one bearing, wherein the plurality of input signals are vibration data and rotational speed data of the at least one bearing.

At Step (204), the method (200) includes converting, by a data segmenting unit (104), the plurality of input signals into a plurality of segments and providing a two-dimensional time frequency representation using a Complex Wavelet Transform (CWT) technique to analyse and visualize multi-resolution properties of the input signals.

At Step (206), the method (200) includes processing, by a feature extracting unit (106), the input vibrational and rotational speed signals and extracting spatial and temporal features for analyzing time-varying speed signals by using Split-Operation Fuzzy CNN (SOF-CNN) technique, wherein the feature extracting unit (106) is further configured to provide a first feature map extracted from the rotational speed signals and a second feature map extracted from the vibrational signals through factorized convolution blocks.

At Step (208), the method (200) includes calculating, by a fuzzy-based classification unit (108), fuzzy scores with fuzzy rule weights on the first feature map and the second feature map by using an implemented matrix multiplication technique, wherein the fuzzy-based classification unit (108) is further configured to compute the degree to which features belong to each fuzzy rule and capture fuzzy relationships in the signals.

At Step (210), the method (200) includes aggregating, by a data aggregating unit (110), the fuzzy scores and providing a crisp feature output by using a de-fuzzy rule layer, wherein the data aggregating unit (110) is further configured to transform the fuzzy scores using the matrix multiplication technique with de-fuzzification weights.

At Step (212), the method (200) includes receiving, by a processing unit (112), the crisp feature output and processing the crisp feature output for final classification of the motor bearing fault.

At Step (214), the method (200) includes classifying, by a classifying unit (114), the motor bearing fault as a healthy motor bearing or a faulty motor bearing based on the de-fuzzified outputs.

In a further embodiment, the signal collecting unit (102) comprising an accelerometer (102a) fixed to housing of the bearing configured to capture vibrations of the bearing and an incremental encoder (102b) configured to record rotational speed of a shaft coupled with the bearing, wherein the incremental encoder (102b) is further configured to record incremental speed, decremental speed, incremental and subsequent decremental speed and a series of decremental and incremental speed.

In one embodiment, processing, by a signal processing unit (116), the signals to minimize edge effects in every segment and reduce discontinuities at boundaries of the signals by using a Hanning window technique, wherein the signal processing unit (116) is further configured to minimize distortions caused by boundary effects. In another embodiment, identifying, by the processing unit (112), uncertainty of the signals by using the least Shannon entropy criterion technique, wherein the processing unit (112) indicates a lower value, which suggests highly relevant content and lower noise content. In another embodiment, applying, by the processing unit (112), Least Shannon Criterion Complex Wavelet Selection technique to effectively identify an optimal complex wavelet type for analyzing vibrational and rotational speed signals.

The pre-processing of the vibrational and rotational time series signals has been done very carefully in order to maintain accuracy and precision in the analyses that follow. First of all, segmentation of the time series signals for a detailed inspection is done. This is important to have the signals divided into manageable parts to ensure better processing and analysis.

For better quality of analysis with less spectral leakage a Hanning window is applied on each segment, which minimizes the edge effects in every segment consequently reducing the discontinuities at the boundaries; one of the major reasons for spectral leakage. This windowed segment ensures that the frequency components of the signal are more accurately represented, minimizing distortions caused by boundary effects. Both segmentation and the Hanning window are applied, successfully preparing the rotational and vibrational signals for in-depth examination in subsequent stages. By ensuring that there is no noticeable spectral leakage in the signals, these preprocessing procedures preserved high fidelity in the workflow of signal processing.

In another embodiment, the wavelet transform is a powerful tool to analyze a signal in terms of varying levels of resolution. Being a powerful tool, there are a wide variety of variants each having its own strength and weakness. However, it is impractical to implement each method and then compare the performance due to the costly phenomenon of acquiring the coefficients and if a scalogram based representation is to be used then the complexity increases. Hence, there are a myriad of evaluation criterion provided which allow for the optimal selection of the mother wavelet for a given problem. One such metric is the least Shannon entropy criterion which identifies the uncertainty or the information content of the signal. The lower value suggests the highly relevant content and lower noise content, therefore the Least Shannon Criterion Complex Wavelet Selection technique is applied to effectively identify the optimal complex wavelet type for analyzing vibrational and rotational data. This approach aimed to minimize Shannon entropy across various fault types, leveraging segmented data and complex wavelet transforms. The proposed wavelet selection technique utilizes the information content from vibrational and rotational speed signals, unlike the contemporary techniques, which usually use vibrational signals for selection. In doing so, different wavelet types are evaluated to understand the response of each type towards varying signal types.

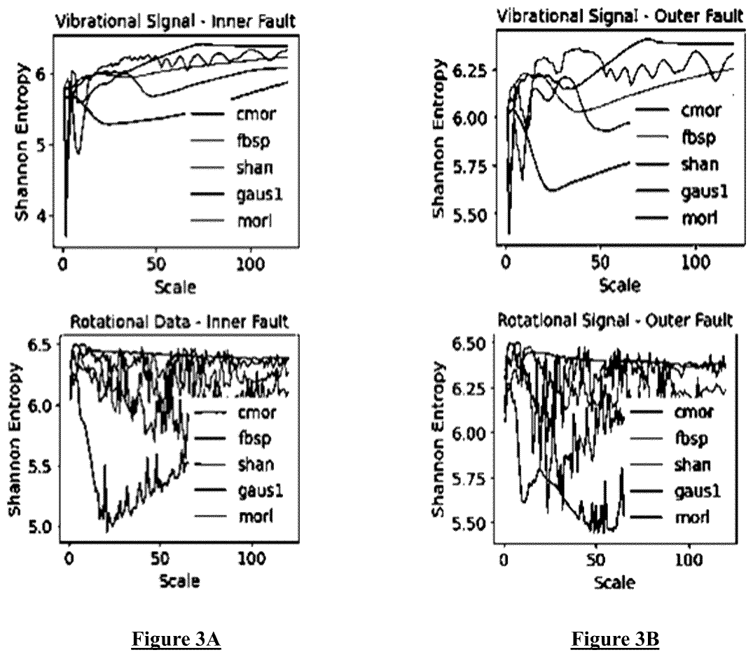

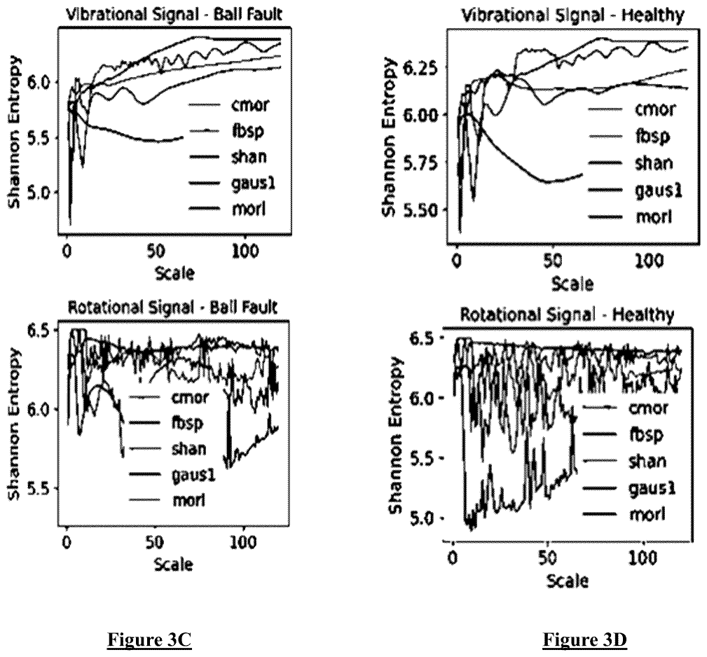

Initially, each fault type within the vibrational and rotational datasets are segmented into 30 segments. These segments facilitate focused analysis of each fault type, ensuring that specific characteristics can be accurately captured and compared. Next, each segment is decomposed into 128 scales using the aforementioned complex wavelet transforms. Shannon entropy is then calculated for each scale and the results shown in FIG. 3A, FIG. 3B, FIG. 3C, and FIG. 3D.

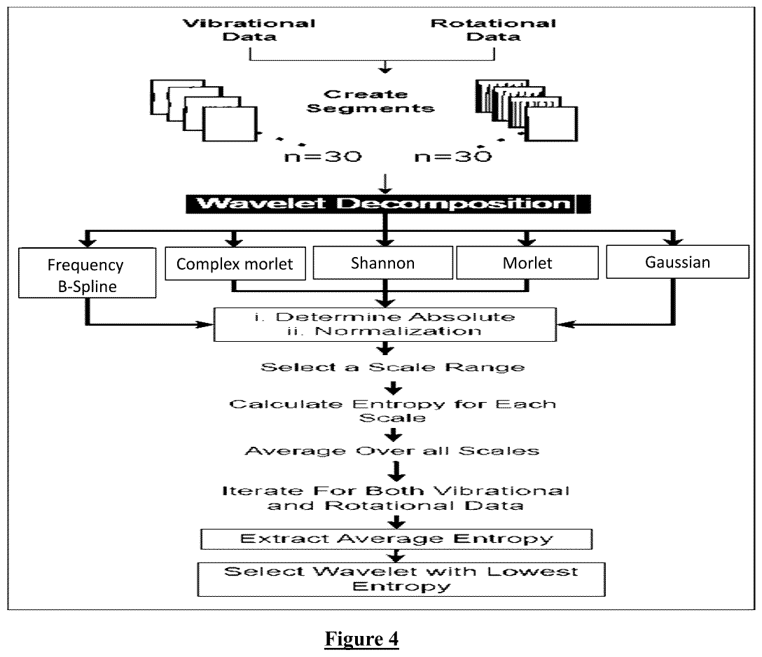

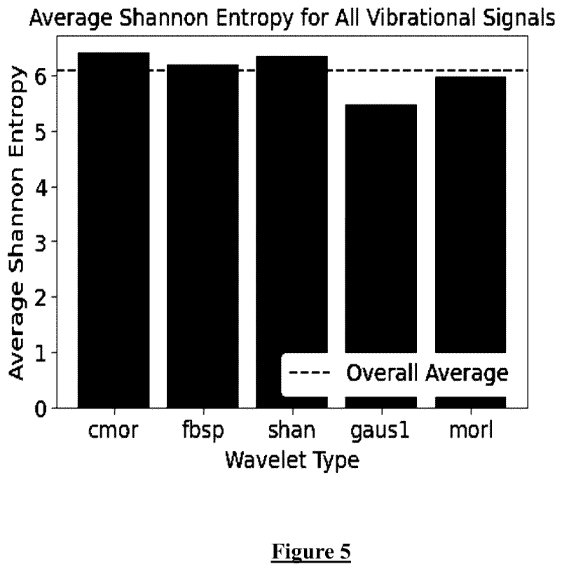

To determine the optimal complex wavelet type for each fault type (vibrational or rotational), the average Shannon entropy across all segments and scales are computed. Finally, the wavelet type with the lowest average Shannon entropy across all fault types and scales are selected. The overall interface for the implementation of the mother-wavelet selection is given in FIG. 4 while the variability in the Average Shannon Entropy results for each of the 5 candidate wavelets are depicted in FIG. 5.

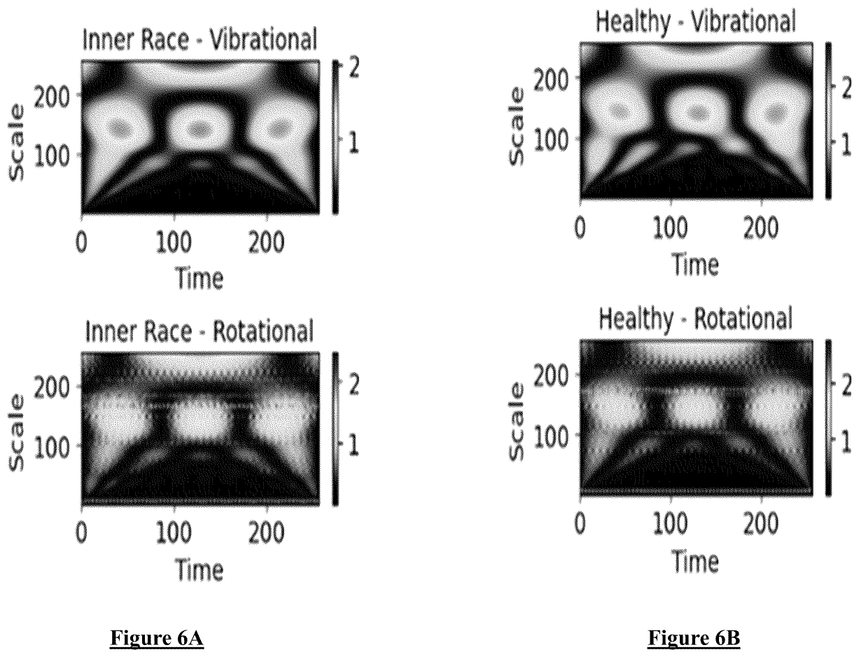

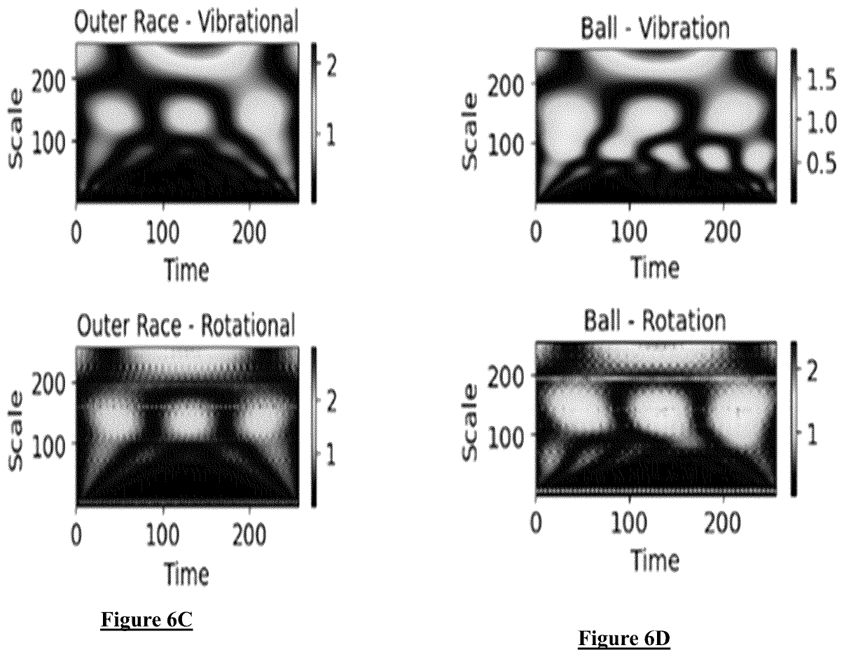

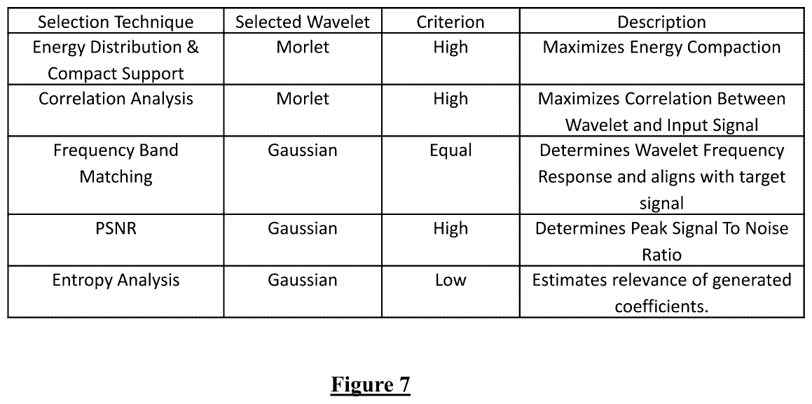

This methodological approach ensures that the complex wavelet type chosen for each fault type (vibrational or rotational) optimally captures the relevant signal characteristics, minimizing information entropy and enhancing diagnostic accuracy. By systematically evaluating different wavelet types and leveraging Shannon entropy as a criterion, this technique provides a robust system for selecting the most suitable wavelet transform in fault diagnosis, with the results of the least Shannon entropy-based wavelet, i.e., gaus1, for both the vibrational and rotational data illustrated in FIG. 6A, FIG. 6B, FIG. 6C, and FIG. 6D. As given in Table illustrated in FIG. 7, different selection techniques are evaluated; however, the outcomes remained persistent to some extent. As a sanity check, the evaluations in terms of energy distribution, correlation analysis, frequency matching, and PSNR are also conducted on individual classes, with the results corroborating the proposed entropy criterion. Furthermore, the use of entropy as a wavelet selection criterion for fault diagnosis remains consistent throughout the years; hence, the proposed technique is established on the premise that the Shannon entropy is used as an effective evaluation criterion for mother wavelet selection.

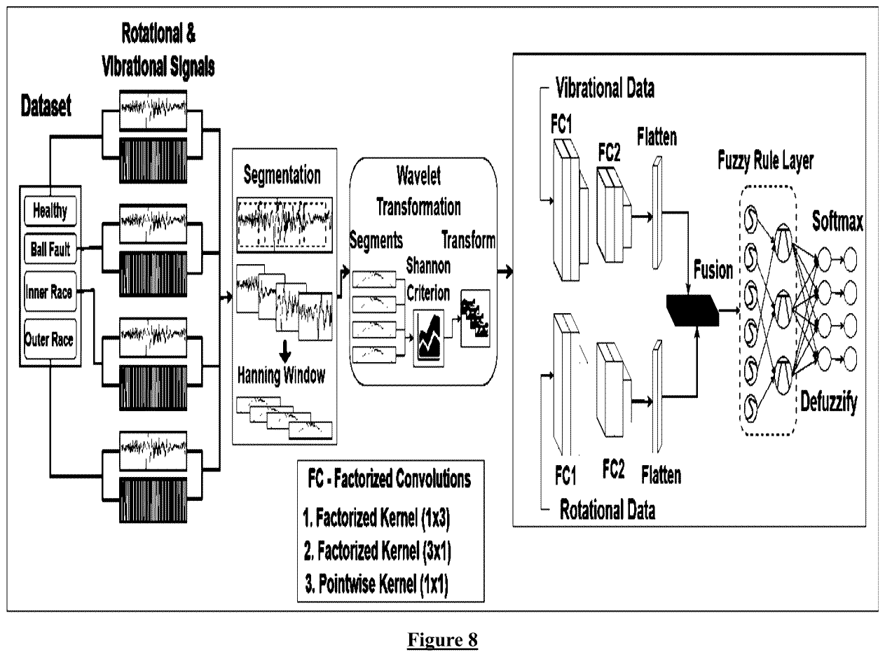

The system proposed in the present disclosure leverages factorized convolutions for the proposed Split-Operation Fuzzy Convolutional Neural Network (SOF-CNN) architecture to handle dual-input wavelet-transformed vibrational and rotational data, extracting both spatial (frequency-domain) and temporal features essential for analyzing time-varying speed signals as depicted in the block diagram illustrated in FIG. 8.

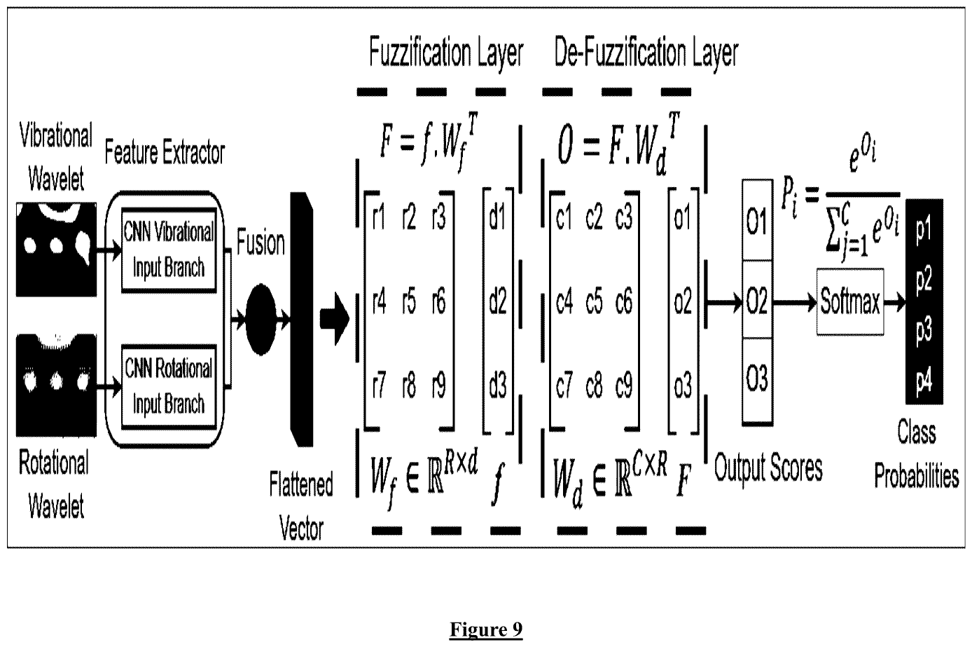

The Fuzzy Layer shown in FIG. 9, initializes with a fixed number of fuzzy rules, represented in the form of an array of trainable weights. On the forward pass, the system takes the inputs and uses matrix multiplication for the calculation of the fuzzy scores with the fuzzy rule weights. This operation computes the degree to which each input feature belongs to each fuzzy rule, capturing fuzzy relationships in the data. The De-Fuzzify Layer initializes with a specified number of outputs, represented as a set of trainable weights. During the forward pass, the fuzzy scores are transformed using matrix multiplication with the de-fuzzification weights. This operation aggregates the fuzzy scores into a crisp output, performing the final classification step.

The dataset used in the present disclosure are acquired through a series of tests using a fault simulator—more specifically, the MFS-PK5M system. The shaft's prime mover is a motor, whose rotational speed is carefully controlled by an AC drive. Two ER16K bearings supported the shaft at both ends; one of them is the experimental bearing and the other one is the control (healthy) bearing. In order to record the experimental bearing's vibrational behavior, an accelerometer (623C01) is fixed to its housing. At the same time, the shaft's rotational speed is accurately recorded and monitored by use of an incremental encoder (EPC 775). This experimental configuration facilitated the comprehensive acquisition of bearing health data under a diverse range of operating conditions.

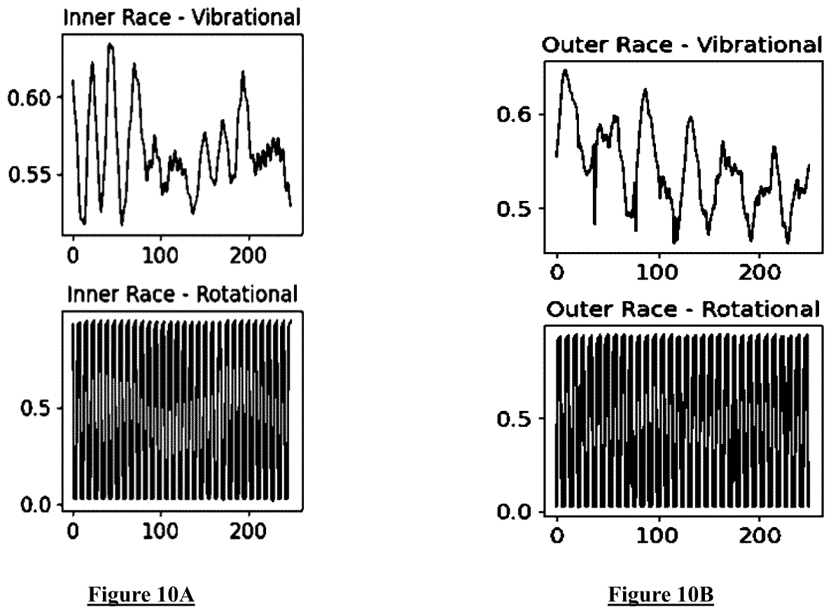

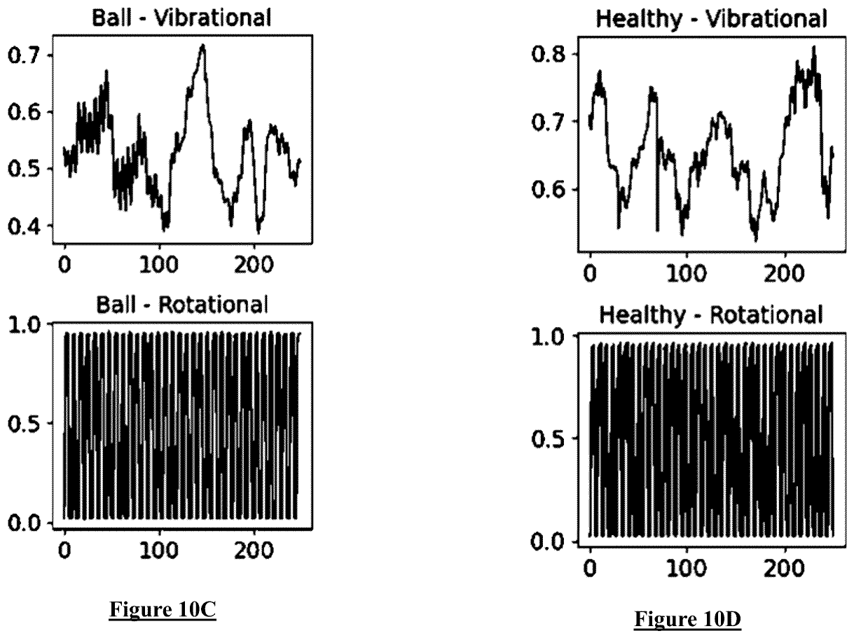

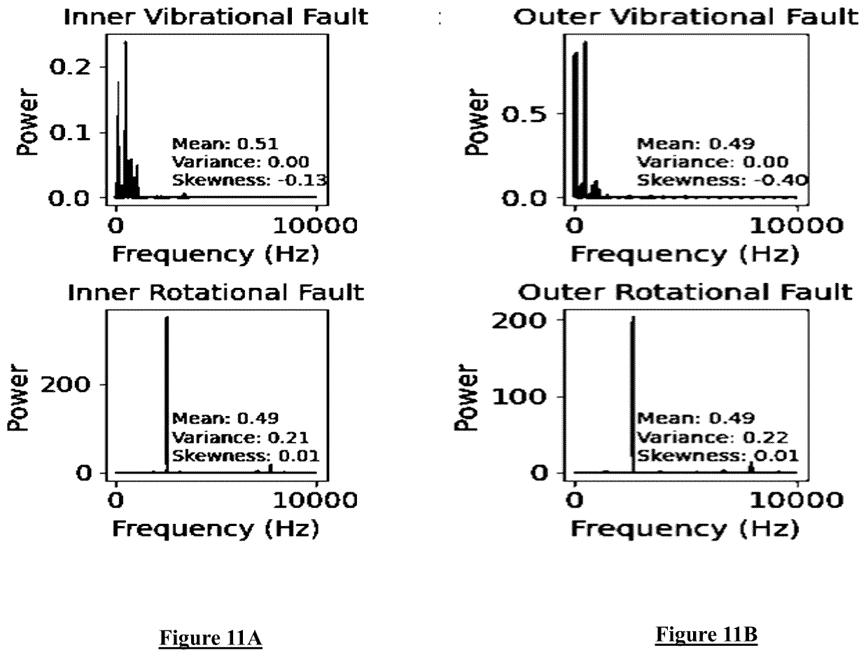

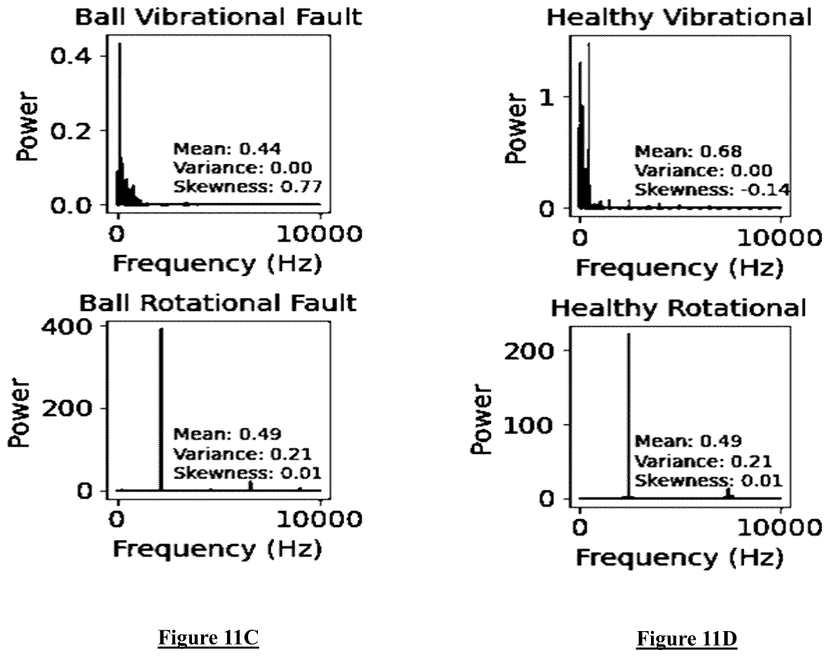

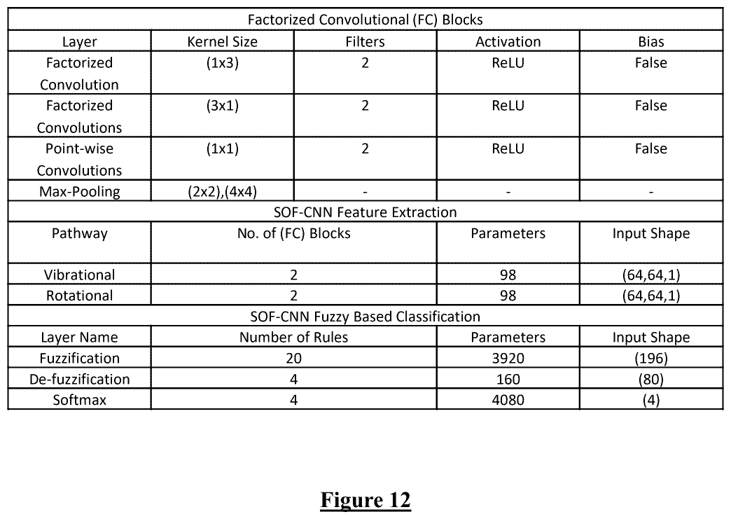

A pristine or normal-clear condition (NC), an inner race fault (IF), an outer race fault (OF), a ball fault (BF), and situations involving multiple concurrent faults (CF) are the five distinct bearing health states that are covered by the iteration of the dataset; with a visualization of both rotational and vibrational characteristics and power spectrum for all four operating conditions given in FIGS. 10A, 10B, 10C, and 10D, and FIGS. 11A, 11B, 11C, and 11D. Additionally, four different rotating speed profiles are used for the data collecting process: incremental speed (IS), decremental speed (DS), incremental and subsequent decremental speed (ITD), and a series of decremental and incremental speed (DTI). The operating conditions that are undertaken for evaluation in the present disclosure are given in Table illustrated in FIG. 12:

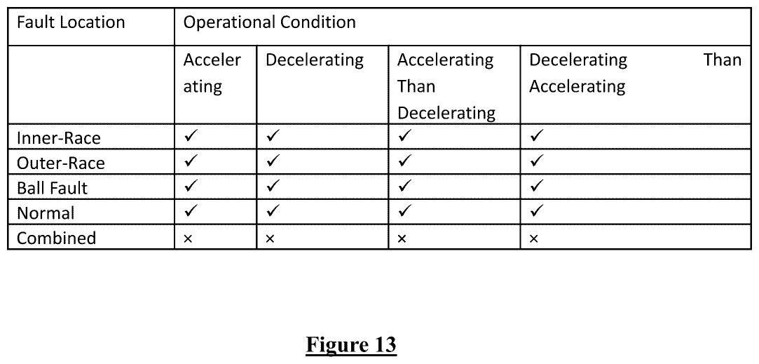

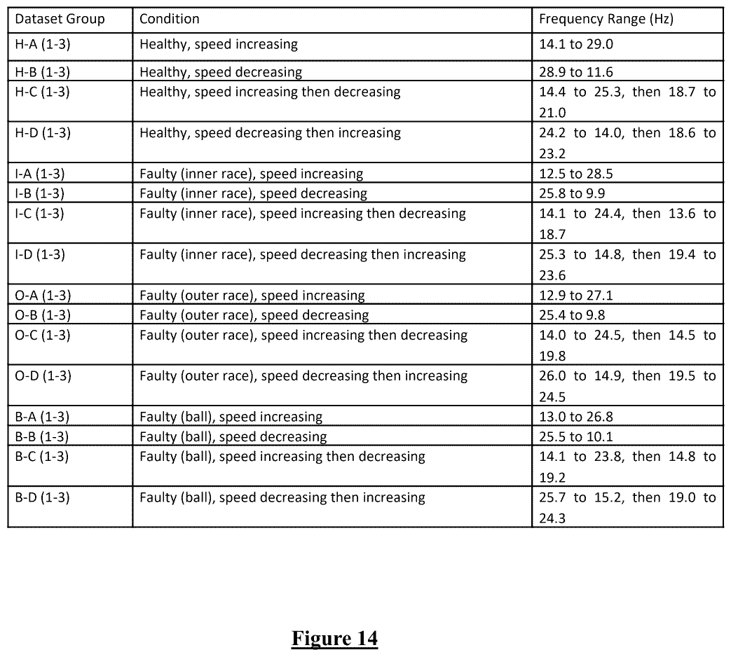

For every rotational speed profile, three experimental trials are carried out under each of the previously specified health conditions in order to improve the reliability of the findings. The duration of each data acquisition session is 10 seconds, and the frequency of sampling is 200 kHz while the rotational frequency is varied for each fault type and operating condition. This process is performed three times for each operational condition. Using an NI USB-6212 BNC data acquisition board, the collected data—which included rotational speed data from the encoder and vibration measurements from the accelerometer ares recorded in a single MATLAB file, with the vibration data going to Channel 1 and the rotational data to Channel 2. The rotational frequency range for each fault type is given in Table 3 as illustrated in FIG. 13 while the selected sample distributions are enlisted in Table 4 as illustrated in FIG. 14.

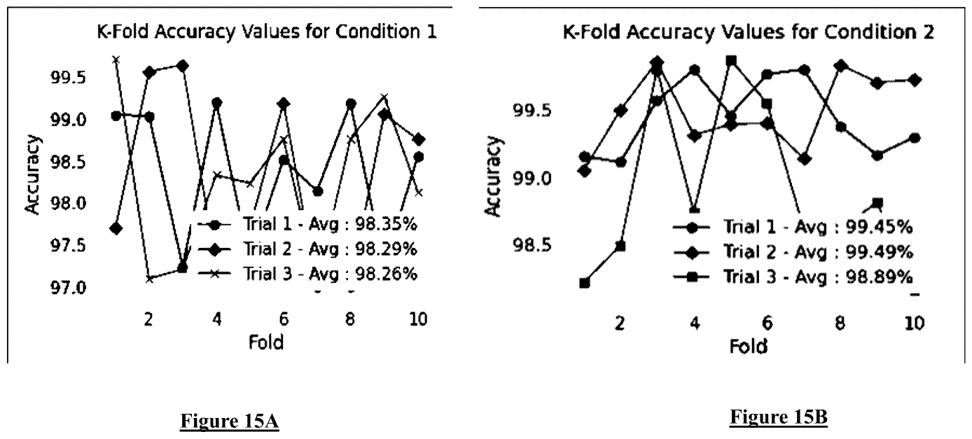

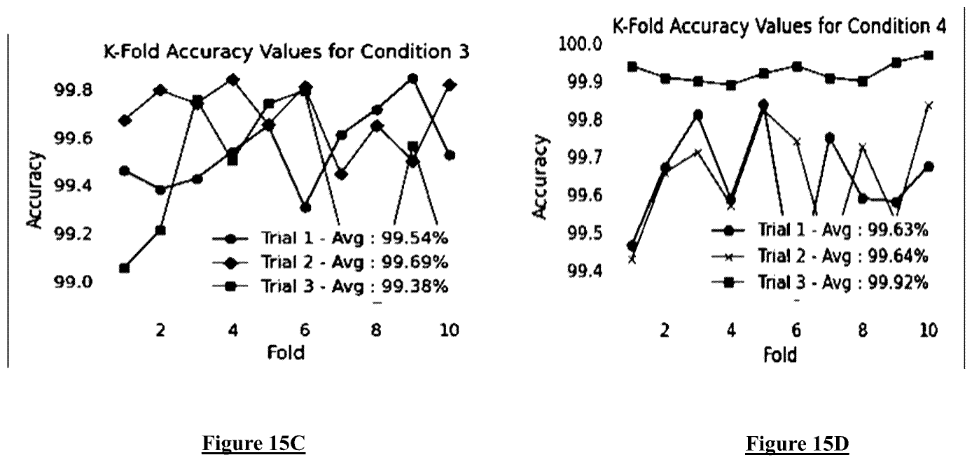

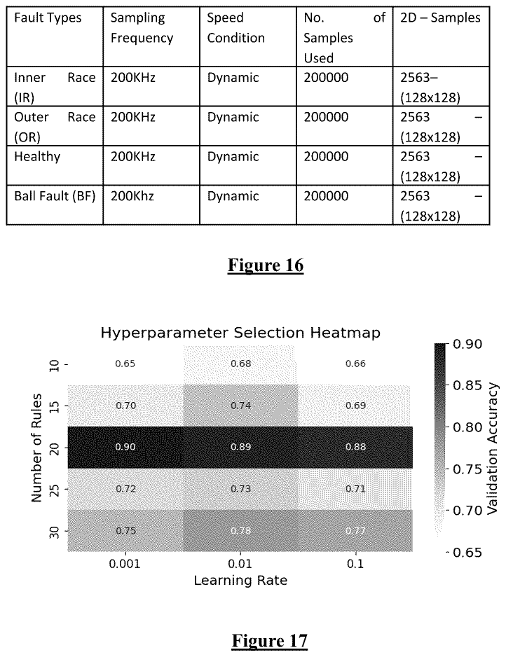

In another embodiment, the effectiveness of the proposed dual-input factorized—CNN using fuzzy logic for bearing defect identification under various operating situations by utilizing both vibrational and rotational data are analysed. K-fold cross-validation is conducted on the first operational condition, considering system stability and consistency across different folds. The 10 Folds accuracy results of all four operating conditions for three trials each are shown in FIG. 15. FIG. 15A illustrates the proposed system's high level of accuracy across all folds, giving an excellent indication of good performance in bearing fault classification under the increasing operational speed condition (C1). In particular, the average accuracy for Trial 1 equals 98.35%, for Trial 2 it is 98.29%, and for Trial 3 it is 98.26% as depicted in Table 5 as illustrated in FIG. 16:

The results suggest the system works consistently across the trials but with small fluctuations. In this case, the accuracy fluctuations across the folds, while the system is stable, could imply that there are some folds with slightly more challenging data distributions than others. This variance is another reason why cross-validation is critical for a reliable system. The k-fold cross-validation results are sufficiently high, showing that the system is consistently of very high accuracy under repeated trials but within the same operational condition.

Similarly, cross-validation on the second operational condition i.e., for decreasing speed (C2) is actually performed in order to check if the system is stable and consistent under different folds. As illustrated in FIG. 15B, the resultant scores of each individual trial of decreasing speed are depicted. The accuracy for different folds is high, meaning the generalization capability of the proposed system for bearing fault classification under this specific operational condition is good. Specifically, for Trial 1, the average accuracy is 99.45%; for Trial 2, the accuracy is 99.49%; and for Trial 3, the accuracy is 98.89% as shown in Table 5. For Condition 3, the K-fold cross-validation results exhibit high and consistent accuracy across all three trials, with Trial 1 achieving an average accuracy of 99.54%, Trial 2 at 99.69%, and Trial 3 at 99.38% as illustrated in FIG. 15C. This consistency highlights the system's robustness in handling the varying speed conditions encapsulated in Condition 3.

Finally, the K-Fold cross-validation results for Condition 4 (C4) i.e., decrease than increase speed demonstrate a consistent high accuracy across all folds and trials. Trial 1 averaged 99.63%, Trial 2 averaged 99.64%, and Trial 3 averaged 99.72%. These result given in FIG. 15D indicate a high level of generalization of the system for this particular condition, suggesting that the system robustly handle the specific characteristics and variations present in C4's data. Critical insights can be drawn from the results.

Hyper-parameter selection is an important regimen, as relevant parameter settings provide optimal outputs. On the other hand, the inappropriate parameter selection results in sub-optimal results, and the system struggles to converge to a minimum. Hence, Grid Search is used to iterate over a specified search space and find the parameters that result in the highest accuracy. Herein, a grid search interface is utilized to iterate over a varying set of fuzzy rules and learning rates to identify the most optimal parameters, by iterating for a limited number of epochs, as illustrated in FIG. 17. The weight distribution for each rule is also shown in FIG. 18 in terms of summed absolute fuzzy rules. It is seen that there is a higher variability as it moves from the 100^{th} feature onwards, while the initial features show a higher degree of uniformity in terms of weight allocation. This further explains the veritable significance associated with the rotational features because of their time-varying nature.

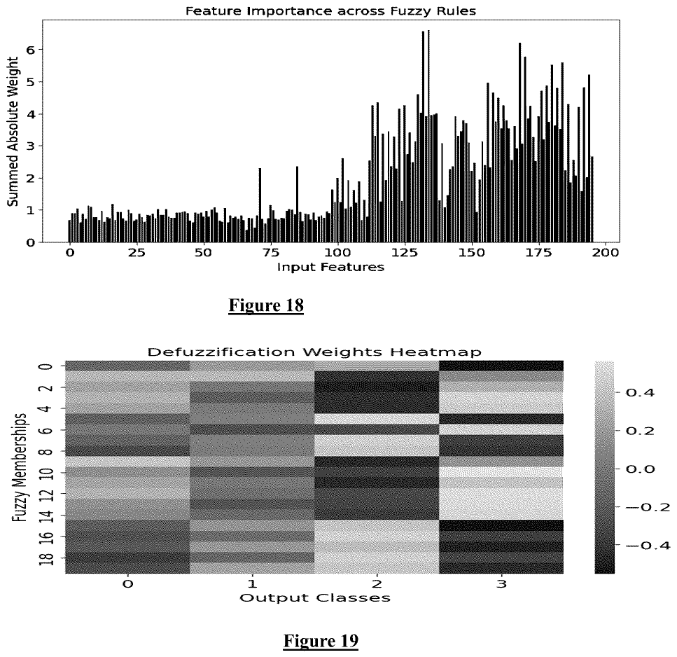

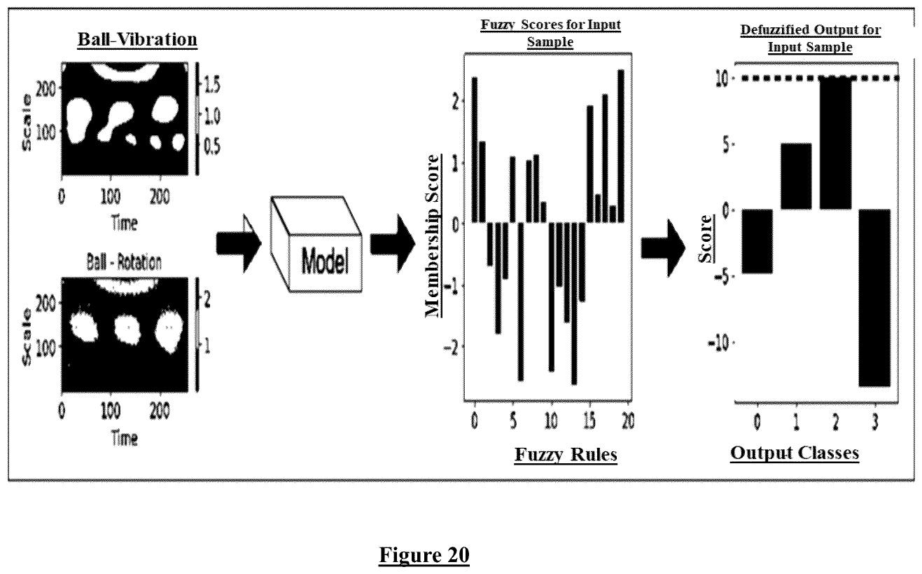

To properly comprehend the Defuzzification process, the fuzzy membership weights for each class are visualized in FIG. 19. It can be observed that each of the 20 rules is assigned a specific value from a common range, akin to a manual membership function generation. However, the integration of fuzzy principles in a trainable system, such as a Convolutional Neural Network, allows for a more specialized and non-laborious system definition capable of generating membership weights with a more nuanced understanding of features and class segregation principles. Finally, the inference on the vibrational and rotational input by the proposed SOF-CNN network is visualized in FIG. 20 to understand the membership score generation for the inputs and the class allocation.

1. A convolution-based dual-input fuzzy system for diagnosing a motor bearing fault, said convolution-based dual-input fuzzy system comprising:
a signal collecting unit configured to collect a plurality of input signals from at least one bearing, wherein the plurality of input signals comprise a plurality of vibrational signals and a plurality of rotational speed signals, said vibrational signals relate to a vibration data and said rotational speed signals relate to a rotational speed data of the at least one bearing;
a data segmenting unit configured to convert the plurality of input signals into a plurality of segments and provide a two-dimensional time frequency representation using a Complex Wavelet Transform (CWT) technique to analyze and visualize multi-resolution properties of the input signals;
a feature extracting unit configured to process the vibrational signals and the rotational speed signals and extract spatial and temporal features for analyzing time-varying speed signals by using Split-Operation Fuzzy CNN (SOF-CNN) technique, wherein the feature extracting unit is further configured to provide a first feature map extracted from the rotational speed signals and a second feature map extracted from the vibrational signals through factorized convolution blocks;
a fuzzy-based classification unit configured to calculate fuzzy scores with fuzzy rule weights on the first feature map and the second feature map by using a matrix multiplication technique, wherein the fuzzy-based classification unit is further configured to compute a degree to which features belong to each fuzzy rule and capture fuzzy relationships in the vibrational signals and rotational speed signals;
a data aggregating unit configured to aggregate the fuzzy scores and provide a crisp feature output by using a de-fuzzy rule layer, wherein the data aggregating unit is further configured to transform the fuzzy scores using the matrix multiplication technique with de-fuzzification weights;
a processing unit configured to receive the crisp feature output from the data aggregating unit and process the crisp feature output for final classification of the motor bearing fault; and
a classifying unit configured to classify the motor bearing fault as a healthy motor bearing or a faulty motor bearing based on de-fuzzified outputs;
wherein the feature extracting unit is configured to preprocess the vibration signals and the rotational speed signals by dividing continuous input streams into a plurality of overlapping frames, each frame being generated through a frame construction technique that continuously evaluates a local variance and a frequency distribution of the vibrational signals and the rotational speed signals, computes an adaptive frame length proportional to said local variance, and assigns an overlap ratio based on an instantaneous rate of change of frequency content, and wherein each constructed frame is normalized by amplitude scaling and baseline shifting before being input to the factorized convolution blocks, and wherein the factorized convolution blocks are further configured to apply a kernel bank of variable dilation rates across the overlapping frames so that both short-lived transient impulses and long-duration oscillatory cycles are structurally encoded in the first feature map and the second feature map; and
wherein the signal collecting unit comprising an accelerometer fixed to housing of the motor bearing configured to capture vibrations of the motor bearing and an incremental encoder configured to record rotational speed of a shaft coupled with the motor bearing, wherein the incremental encoder is further configured to record incremental speed, decremental speed, incremental and subsequent decremental speed and a series of decremental and incremental speed; and wherein the processing unit is configured to identify uncertainty of the vibrational signals and rotational speed signals by using a Shannon entropy criterion technique, wherein the processing unit indicates a lower value, which suggests highly relevant content and lower noise content; and wherein the processing unit is configured to apply Least Shannon Criterion Complex Wavelet Selection technique to effectively identify an optimal complex wavelet type for analyzing vibrational and rotational speed signals ; and wherein the factorized convolution blocks of the feature extracting unit are configured to execute a kernel reassignment routine across a feature extraction path of the rotational speed signals and a feature extraction path of the vibrational signals, the kernel reassignment routine comprising computing a correlation matrix between localized subsections of the rotational speed signals and corresponding subsections of the vibrational signals, updating a similarity threshold dynamically in each processing cycle as a function of an average correlation of previously processed subsections, and transferring active convolution kernels between the feature extraction path of the rotational speed signals and the feature extraction path of the vibrational signals, when correlation values exceed the similarity threshold, while independently reinitializing kernels when correlation values fall below the similarity threshold, and wherein the kernels that are reassigned are retrained using gradient update rules applied simultaneously across both paths to maintain synchronized structural encoding of correlated subsections.

2. The system of claim 1, further comprising a signal processing unit configured to process the vibrational signals and the rotational speed signals to minimize edge effects in every segment and reduce discontinuities at boundaries of the vibrational signals and the rotational speed signals by using a Hanning window technique, wherein the signal processing unit is further configured to minimize distortions caused by boundary effects.

3. The system of claim 1, wherein the feature extracting unit is further configured to apply parallelized convolution operations across segmented inputs by distributing multiple segments simultaneously to independent convolutional cores, each core being assigned a subset of kernels with fixed dilation and stride values, and wherein outputs from parallel cores are concatenated along a feature dimension, reordered by temporal indices, and recombined into feature maps of the rotational speed signals and the vibrational signals without altering temporal alignment across segments.

4. The system of claim 1, wherein the fuzzy-based classification unit is configured to calculate the fuzzy rule weights through a hierarchical fuzzification framework, the hierarchical fuzzification framework comprising a first fuzzification stage in which each said feature in the first and second feature maps is assigned a preliminary membership degree by evaluating its instantaneous magnitude together with its temporal derivative calculated over a sliding analysis window, a second fuzzification stage in which the preliminary membership degree is recalibrated by computing inter-feature similarity indices across spatially adjacent feature nodes, adjusting membership values based on an average similarity of each feature to its neighbors, and a tensor construction stage in which recalibrated membership values are assembled into a multi-dimensional rule activation tensor indexed by feature position and rule identifier, the multi-dimensional rule activation tensor being stored in memory prior to application of the fuzzy rule weights; and
wherein the fuzzy-based classification unit further comprises a conflict resolution sub-module configured to operate on the multi-dimensional rule activation tensor whenever multiple fuzzy rules achieve overlapping membership degrees for a given feature node, the conflict resolution sub-module being configured to generate a temporal persistence profile for each fuzzy rule by recording activation magnitudes across sequential time windows, calculate persistence coefficients proportional to cumulative activation strength of each of the fuzzy rules, rank the fuzzy rules for each feature node according to the persistence coefficients, and update the multi-dimensional rule activation rule activation tensor by retaining the fuzzy rules with the persistence coefficient that is highest while suppressing overlapping rules, such that an updated tensor contains only rule activations that satisfy a persistence criteria across time.

5. The system of claim 1, wherein the fuzzy-based classification unit is further configured to incorporate a feedback adaptation mechanism that modifies the fuzzy rule weights in response to persistent classification discrepancies, the feedback adaptation mechanism comprising detecting repeated conflicts between vibration-derived classifications and rotation-derived classifications, calculating a correction coefficient proportional to the two-dimensional time frequency of such conflicts, and applying the correction coefficient to adjust the fuzzy rule weights of conflicting rules in subsequent fuzzification cycles; and
wherein the fuzzy-based classification unit further comprises a temporal smoothing engine configured to monitor membership value fluctuations across successive time windows, compute moving averages of membership activations, and substitute raw membership values with smoothed averages whenever variance exceeds a preset fluctuation threshold, the membership activations being used for further de-fuzzification.

6. The system of claim 1, wherein the data aggregating unit is configured to transform fuzzy membership values into crisp feature outputs through a structured two-pass de-fuzzification operation, the structured two-pass de-fuzzification operation comprising a first pass in which the fuzzy membership values are arranged into a rule-feature matrix, multiplied with a weight matrix calibrated during system initialization, and aggregated into preliminary crisp values, and a second pass in which dispersion of membership activations across rules is computed as a dispersion index, the dispersion index being applied to modify coefficients of the weight matrix, and wherein a modified weight matrix is applied in a repeated matrix multiplication with the fuzzy membership values to produce final crisp feature outputs, the final crisp feature outputs being transmitted to the processing unit; and
wherein the data aggregating unit is configured to execute a weighted normalization procedure on fuzzy scores before applying de-fuzzification, the weighted normalization procedure comprising summing membership activations across all fuzzy rules, computing a normalization constant, dividing each membership activation by the normalization constant, and scaling normalized activations using rule-specific weight multipliers stored in memory, the normalized activations that are scaled are being arranged into a normalized rule-feature matrix for subsequent crisp value computation.

7. The system of claim 2, wherein the processing unit is configured to apply a complex wavelet selection routine by computing least Shannon entropy values for candidate wavelet functions applied to the vibration signals and the rotational speed signals, ranking the candidate wavelet functions according to entropy values, selecting the candidate wavelet functions with lowest entropy for subsequent time-frequency transformation, and updating the selection dynamically when incoming signals exhibit changes in the Shannon entropy values that alter the ranking of candidate wavelets; and
wherein the processing unit is configured to generate diagnostic reports by recording final classification outputs together with intermediate crisp outputs, fuzzy scores, and stability indices, storing said diagnostic reports in a structured log file with time stamps synchronized to encoder pulses, and transmitting the structured log file to an external monitoring interface for review of historical motor bearing fault conditions.

8. The system of claim 1, wherein the processing unit is configured to maintain a temporal verification buffer that continuously stores a rolling sequence of crisp feature outputs received from the data aggregating unit, the temporal verification buffer being organized as a first-in-first-out structure with insertion of each new crisp output at a leading edge and removal of an oldest entry, and wherein the processing unit executes a frame alignment routine in which each crisp output is timestamped with rotational position markers generated by the incremental encoder, the outputs being compared across the temporal verification buffer through a majority consensus technique that counts the two-dimensional time frequency of recurring classifications within the temporal verification buffer, and wherein the processing unit) computes a stability index equal to the adaptive frame length proportional of matching classifications within the temporal verification buffer, and only transmits a classification signal to the classifying unit when a stability index meets or exceeds a predetermined threshold.

9. The system of claim 1, wherein the processing unit is further configured to execute an entropy filtering procedure on crisp outputs prior to their insertion into a temporal verification buffer, the entropy filtering procedure comprising calculating an entropy value from the frequency distribution of the crisp outputs within a sliding observation window, updating the entropy value incrementally with each new output, comparing the entropy value to a dynamically maintained control threshold, tagging crisp feature outputs with entropy values greater than the dynamically maintained control threshold as uncertain, reducing their insertion weight in the temporal verification buffer, and tagging crisp outputs with entropy values less than the dynamically maintained control threshold as certain and inserting them with full weight, and wherein a stability index of the temporal verification buffer is calculated using weighted entries to reflect both certain and uncertain classifications.

10. The system of claim 8, wherein the processing unit is configured to apply a synchronization module that aligns the crisp feature output with both vibration signal frames and rotational speed segments, the synchronization module comprising calculating an index offset between frame timestamps derived from accelerometer data and rotational cycle markers derived from incremental encoder pulses, adjusting buffer insertion points according to the index offset, and reordering crisp outputs in the temporal verification buffer to match synchronized vibration and rotation cycles before stability index calculation, and
wherein the processing unit is further configured to maintain a dual-layer buffer structure comprising a primary short-term buffer that stores crisp outputs across a limited number of recent windows and a secondary long-term buffer that stores consensus outputs from a primary buffer over extended operational intervals, and wherein the processing unit compares classification results across the primary short-term buffer and the secondary long-term buffer, calculates a divergence index measuring consistency between short-term and long-term consensus values, and restricts progression to the classifying unit if the divergence index exceeds a preset tolerance limit.

11. The system of claim 1, wherein the processing unit is further configured to apply an anomaly detection filter to crisp outputs prior to classification, the anomaly detection filter comprising computing deviation values by comparing current crisp outputs against a rolling baseline average, updating the baseline average incrementally with each new output, and flagging crisp outputs with deviations exceeding a deviation threshold as anomalies, such anomalies being stored in a separate anomaly register and excluded from stability index calculations; and
wherein the processing unit is configured to maintain a hierarchical memory structure for storing crisp outputs, the hierarchical memory structure comprising a first-tier memory for short-term storage of raw crisp outputs, a second-tier memory for aggregated consensus results, and a third-tier archival memory for storing long-term classification histories together with entropy metrics and stability indices, and wherein the processing unit executes periodic consistency checks by comparing results across tiers to ensure continuity of stored diagnostic data.

12. The system of claim 1, wherein the classifying unit is configured to finalize diagnostic labels using a two-stage validation process, the two-stage validation process comprising a first validation stage in which crisp outputs from the processing unit are aggregated into partially overlapping temporal windows, each temporal window being processed through majority voting to yield a local classification result, and a second validation stage in which a probability distribution is constructed across the local classification result, an entropy measure is computed from the probability distribution, and the diagnostic labels being finalized only when the entropy measure falls below a predefined limit, the diagnostic labels that are finalized being stored as a motor bearing fault state; and
wherein the classifying unit is configured to execute a redundancy verification operation by comparing the diagnostic labels generated from vibration-derived features with diagnostic labels generated independently from rotational speed-derived features, the redundancy verification operation comprising isolating the crisp outputs of the feature extraction path of the rotational speed signals and the feature extraction path of the vibration signals prior to aggregation, computing independent classifications for each path, and passing the diagnostic labels that are finalized only when both independent classifications match, while in case of mismatch, deferring classification and requesting recalibration of feature extraction parameters.

13. The system of claim 1, wherein the classifying unit further comprises a hierarchical decision fusion module configured to combine classifications across multiple operational states of the motor bearing, the hierarchical decision fusion module comprising constructing a classification vector for each operational state from its associated crisp outputs, arranging the classification vector into a decision matrix, calculating inter-vector similarity scores, and producing a fused classification decision by applying weighted voting across rows of the decision matrix, with the weighted voting assigned proportional to the inter-vector similarity scores of the respective classification vectors.

14. The system of claim 1, wherein the classifying unit is further configured to apply a state transition verification mechanism, the state transition verification mechanism comprising recording a sequence of diagnostic labels over time, constructing a state transition matrix from the sequence being recorded, comparing a current state transition against predefined permissible transitions, and withholding final classification output when a detected transition does not match any permissible pattern, a withheld output being queued until additional verification cycles are completed; and
wherein the classifying unit is further configured to implement a multi-resolution decision analysis, the multi-resolution decision analysis comprising processing diagnostic labels at multiple aggregation levels including frame-level, window-level, and cycle-level, arranging results into a hierarchical decision structure, applying weighted voting across the hierarchical decision structure, and generating a final motor bearing diagnostic state based on aggregated decisions from all levels of the hierarchical decision structure.

15. The system of claim 1, wherein the signal collecting unit is further configured to execute synchronous sampling of the vibration signals and the rotational speed signals, the synchronous sampling comprising generating synchronization markers based on encoder pulses, sampling vibration data at each synchronization marker, constructing a combined signal record comprising time-aligned vibration and rotation samples, and transmitting the combined signal record to the data segmenting unit for subsequent conversion into time-frequency segments; and
wherein the signal collecting unit is further configured to execute a multi-sensor calibration sequence prior to signal acquisition, the multi-sensor calibration sequence comprising:
generating controlled test pulses from the incremental encoder and simultaneously capturing vibration responses from the accelerometer;
calculating phase offsets between encoder pulses and accelerometer signals; and
applying corrective phase alignment coefficients to subsequent vibration signal recordings, such that all acquired signals are phase-synchronized before being forwarded to the data segmenting unit.

16. The system of claim 2, wherein the signal processing unit is configured to apply a Hanning window function to each segment by calculating overlapping window functions, multiplying each signal segment by Hanning coefficients to taper boundary amplitudes, recombining adjacent windowed segments to minimize discontinuities, and verifying distortion reduction by performing spectral analysis on recombined segments to confirm suppression of boundary artifacts before feature extraction.

17. The system of claim 1, wherein the data segmenting unit is configured to apply a complex wavelet transform by selecting mother wavelets from a candidate library, decomposing the vibration signals and the rotational speed signals into multiple resolution levels, constructing a two-dimensional time-frequency matrix for each signal, and aligning the two-dimensional time-frequency matrix for each signal to produce a synchronized two-dimensional representation, the synchronized two-dimensional representation being forwarded to the feature extracting unit for convolution-based analysis; and wherein the data segmenting unit is further configured to implement an adaptive overlap management routine, said adaptive overlap management routine comprising measuring the instantaneous rate of frequency change within each segment of the vibration signals and the rotational speed signals, assigning higher overlap percentages for segments with rapid frequency variation and lower overlap percentages for segments with relatively uniform content, and dynamically updating overlap values as new signal segments arrive, wherein the segments that overlap are reconstructed into a continuous time-frequency plane for subsequent analysis.

18. A convolution-based dual-input fuzzy method for diagnosing a motor bearing fault using system as claimed in claim 1, said method comprising:
collecting a plurality of input signals from at least one bearing, wherein the plurality of input signals comprise a plurality of vibrational signals and a plurality of rotational speed signals, said vibrational signals relate to a vibration data and said rotational speed signals relate to a rotational speed data of the at least one bearing;
converting the plurality of input signals into a plurality of segments and providing a two-dimensional time frequency representation using a Complex Wavelet Transform (CWT) technique to analyze and visualize multi-resolution properties of the input signals;
processing the vibrational signals and the rotational speed signals and extracting spatial and temporal features for analyzing time-varying speed signals by using Split-Operation Fuzzy CNN (SOF-CNN) technique, and providing a first feature map extracted from the rotational speed signals and a second feature map extracted from the vibrational signals through factorized convolution blocks;
calculating fuzzy scores with the fuzzy rule weights on the first feature map and the second feature map by using an implemented matrix multiplication technique, computing the degree to which features belong to each fuzzy rule and capture fuzzy relationships in the vibrational signals and the rotational speed signals;
aggregating the fuzzy scores and providing a crisp feature output by using a de-fuzzy rule layer, and transforming the fuzzy scores using the matrix multiplication technique with de-fuzzification weights;
receiving the crisp feature output and processing the crisp feature output for final classification of the motor bearing fault; and
classifying the motor bearing fault as a healthy motor bearing or a faulty motor bearing based on the de-fuzzified outputs.

19. The method of claim 18, further comprising:
processing the vibrational signals and the rotational speed signals to minimize edge effects in every segment and reduce discontinuities at boundaries of the vibrational signals and the rotational speed signals by using a Hanning window technique;
identifying uncertainty of the vibrational signals and the rotational speed signals by using the least Shannon entropy criterion technique; and
identifying an optimal complex wavelet type for analyzing the vibrational signals and the rotational speed signals.
